(19) United States
(12) Patent Application Publication
(10) Pub. No.: US 2022/0404081 A1
(43) Pub. Date: Dec. 22, 2022

(54) THERMAL MANAGEMENT SYSTEMS

(71) Applicant: Booz Allen Hamilton Inc., McLean, VA (US)

(72) Inventors: Igor Vaisman, Carmel, IN (US); Joshua Peters, Knoxville, TN (US)

(21) Appl. No.: 17/846,955

(22) Filed: Jun. 22, 2022

Related U.S. Application Data
(60) Provisional application No. 63/213,327, filed on Jun. 22, 2021.

(51) Int. Cl. F25B 49/02; F25B 45/00; F25B 41/31

(52) U.S. Cl. CPC F25B 49/02; F25B 45/00; F25B 41/31; F25B 2400/16; F25B 2400/03; F25B 2341/0011; F25B 2400/19

(57) ABSTRACT

A thermal management system includes a closed-circuit refrigeration system that includes a closed-circuit refrigerant fluid path configured to store a refrigerant fluid; and an absorber/desorber including a bidirectional port coupled to the closed-circuit refrigerant fluid path to regulate an amount of refrigerant vapor at a compressor inlet of the closed-circuit refrigeration system. The absorber/desorber is configured to store an ionic liquid that is configured to absorb or desorb at least a portion of the refrigerant vapor based on a mode of operation of the absorber/desorber.

### CLAIM OF PRIORITY

This application claims priority under 35 USC § 119(e) to U.S. Provisional Patent Application Ser. No. 63/213,327, filed on Jun. 22, 2021, and entitled “THERMAL MANAGEMENT SYSTEMS,” the entire contents of which are hereby incorporated by reference.

### BACKGROUND

Refrigeration systems absorb thermal energy from heat sources operating at temperatures below the temperature of the surrounding environment and discharge thermal energy into the surrounding environment. Heat sources operating at temperatures above the surrounding environment can be naturally cooled by the surrounding if there is direct contact between the source and the environment.

Conventional refrigeration systems include a compressor, a heat rejection exchanger (i.e., a condenser), a receiver, an expansion device, and a heat absorption exchanger (i.e., an evaporator). Such systems can be used to maintain operating temperature set points for a wide variety of cooled heat sources (loads, processes, equipment, systems) thermally interacting with the evaporator. Closed-circuit refrigeration systems may pump significant amounts of absorbed thermal energy from heat sources into the surrounding environment.

In closed-circuit systems, compressors are used to compress vapor from an evaporating pressure the evaporator and to a condensing pressure in the condensers and condense the compressed vapor converting the vapor into a liquid at a temperature higher than the surrounding environment temperature. The combination of condensers and compressors can add a significant amount of weight and can consume relatively large amounts of electrical power. In general, the larger the amount of absorbed thermal energy that the system is designed to handle, the heavier the refrigeration system and the larger the amount of power consumed during operation, even when cooling of a heat source occurs over relatively short time periods.

In some cases the surrounding environment temperature can appear below the heat source temperature. The refrigeration system provides a contact via refrigerant. There may be no need to compress vapor from the evaporating to condensing pressure since condensation can happen at a pressure slightly higher or even below the evaporating pressure.

### SUMMARY

This disclosure describes techniques related to systems and methods for thermal management. In an example implementation, a thermal management system includes a closed-circuit refrigeration system that includes a closed-circuit refrigerant fluid path configured to store a refrigerant fluid; and an absorber/desorber including a bidirectional port coupled to the closed-circuit refrigerant fluid path to regulate an amount of refrigerant vapor at a compressor inlet of the closed-circuit refrigeration system. The absorber/desorber is configured to store an ionic liquid that is configured to absorb or desorb at least a portion of the refrigerant vapor based on a mode of operation of the absorber/desorber.

In an aspect combinable with the example implementation, the closed-circuit refrigeration system further includes a receiver disposed in the closed-circuit refrigerant fluid path and including a receiver inlet and a receiver outlet, at least one evaporator disposed in the closed-circuit refrigerant fluid path and including an evaporator inlet and an evaporator outlet, at least one compressor disposed in the closed-circuit refrigerant fluid path and including the compressor inlet and a compressor outlet, and at least one condenser disposed in the closed-circuit refrigerant fluid path and including a condenser inlet and a condenser outlet.

In another aspect combinable with any of the previous aspects, the evaporator inlet is configured to receive the refrigerant fluid from the receiver, remove heat from at least one heat load by converting at least a portion of a refrigerant liquid to refrigerant vapor, and deliver the refrigerant vapor to the evaporator outlet.

In another example implementation, a thermal management system includes a closed-circuit refrigeration system having a closed-circuit refrigerant fluid path that includes a receiver including a receiver inlet and a receiver outlet, the receiver configured to store a refrigerant fluid, at least one evaporator including an evaporator inlet and an evaporator outlet, the evaporator inlet configured to receive the refrigerant fluid from the receiver, remove heat from at least heat load by converting at least a portion of the refrigerant fluid to refrigerant vapor, and deliver the refrigerant vapor to the evaporator outlet; a compressor including a compressor inlet and a compressor outlet, and a condenser including a condenser inlet and a condenser outlet. The system further includes an absorber/desorber that includes a bidirectional port fluidly coupled to the closed-circuit refrigerant fluid path to regulate an amount of refrigerant vapor at the compressor inlet, the absorber/desorber configured to store an ionic liquid that absorbs or desorbs refrigerant vapor according to a mode of operation of the absorber/desorber.

An aspect combinable with the example implementation further includes an expansion valve configured to expand the refrigerant fluid from the receiver into a two-phase liquid-vapor refrigerant stream.

Another aspect combinable with any of the previous aspects further includes a suction accumulator that includes an inlet coupled to the evaporator outlet, and a vapor-side outlet coupled to the compressor inlet.

Another aspect combinable with any of the previous aspects further includes a sensor configured to sense a thermodynamic property of the refrigerant vapor at the evaporator outlet and produce a signal to directly or indirectly control operation of the expansion valve.

In another aspect combinable with any of the previous aspects, the ionic liquid in the absorber/desorber is configured to absorb a portion of the refrigerant vapor in the closed-circuit refrigerant fluid path when the absorber/desorber operates as an absorber.

In another aspect combinable with any of the previous aspects, the ionic liquid in the absorber/desorber is configured to desorb the refrigerant vapor stored in the absorber/desorber into the closed-circuit refrigerant fluid path when the absorber/desorber operates as a desorber.

In another aspect combinable with any of the previous aspects, the absorber/desorber is configured to neither absorb vapor from the closed-circuit refrigerant fluid path by the ionic liquid nor desorb vapor stored by the ionic liquid in the absorber/desorber into the closed-circuit refrigerant fluid path.

In another aspect combinable with any of the previous aspects, the closed-circuit refrigeration system further includes a suction accumulator including an inlet that is coupled to the evaporator outlet and a vapor-side outlet that is coupled to the compressor inlet; and a recuperative heat exchanger that includes a first refrigerant path disposed between the receiver outlet and the evaporator inlet, and a second refrigerant path disposed between the vapor-side outlet and the compressor inlet.

In another aspect combinable with any of the previous aspects, the closed-circuit refrigeration system further includes an ejector that includes a primary inlet disposed to receive refrigerant fluid from the receiver, a secondary inlet, and an ejector outlet; a liquid separator including an inlet, a vapor-side outlet, and a liquid-side outlet; and an expansion valve that includes an expansion valve inlet coupled to the liquid-side outlet of the liquid separator, and an expansion valve outlet.

In another aspect combinable with any of the previous aspects, the secondary inlet of the ejector is disposed to receive refrigerant from the evaporator outlet, with the evaporator configured to convert a portion of the refrigerant fluid received from the expansion valve outlet to refrigerant vapor, and to deliver the refrigerant fluid including the converted refrigerant vapor to the secondary inlet.

In another aspect combinable with any of the previous aspects, the secondary inlet of the ejector is disposed to receive refrigerant from the expansion valve outlet and the evaporator is disposed to receiver refrigerant fluid from the ejector outlet.

In another aspect combinable with any of the previous aspects, the evaporator is a first evaporator, and the thermal management system further includes a second evaporator including an inlet and an outlet, with the inlet of the second evaporator disposed to receive refrigerant from the ejector outlet.

Another aspect combinable with any of the previous aspects further includes a sensor configured to sense a thermodynamic property of the refrigerant vapor at the outlet of the first evaporator to produce a sensor signal to directly or indirectly control operation of the expansion valve.

In another aspect combinable with any of the previous aspects, the evaporator has a first fluid path and a second fluid path, with the ejector outlet coupled to an inlet of the first fluid path and an outlet of the first fluid path coupled to an inlet of the liquid separator, and with an inlet of the second fluid path coupled to the expansion valve outlet and an outlet of the second fluid path coupled to the secondary inlet of the ejector.

In another aspect combinable with any of the previous aspects, the closed-circuit refrigeration system further includes a liquid separator including an inlet, a vapor-side outlet, and a liquid-side outlet; and a pump including a pump inlet and a pump outlet, with the pump inlet disposed to receive a refrigerant liquid from the liquid-side outlet of the liquid separator.

In another aspect combinable with any of the previous aspects, the pump outlet is fluidly coupled to the evaporator inlet.

In another aspect combinable with any of the previous aspects, the evaporator is a first evaporator and the evaporator inlet is a first evaporator inlet and the evaporator outlet is a first evaporator outlet, and the thermal management system further includes a second evaporator including a second evaporator inlet and a second evaporator outlet with the second evaporator inlet configured to receive refrigerant fluid from the first evaporator outlet.

In another aspect combinable with any of the previous aspects, the evaporator has a first fluid path and a second fluid path, with the pump including the outlet coupled to an inlet of the first fluid path and including an outlet of the first fluid path coupled to an inlet of the second fluid path that also receives refrigerant from the receiver, and with the outlet of the second fluid path coupled to the inlet of the liquid separator.

Another aspect combinable with any of the previous aspects further includes a modulating capacity control circuit configured to modulate cooling capacity of the closed-circuit refrigeration system based at least in part on a cooling capacity demand on the closed-circuit refrigeration system that results at least in part from extraction of the heat from the at least one heat load, the modulating capacity control circuit configured to split compressed refrigerant vapor received from the compressor outlet into a first compressed portion and a second compressed portion, with the first compressed portion diverted to the condenser inlet.

In another aspect combinable with any of the previous aspects, the modulating capacity control circuit is configured to divert a first sub-portion of the second compressed portion to the receiver inlet.

In another aspect combinable with any of the previous aspects, the modulating capacity control circuit is configured to divert a second sub-portion of the second compressed portion towards the compressor inlet.

In another aspect combinable with any of the previous aspects, the modulating capacity control circuit includes a head pressure valve including a first inlet coupled to the condenser outlet, a second inlet disposed to receive a first sub-portion of the first compressed portion, and an outlet coupled to the receiver inlet, with the head pressure valve configured to divert the first sub-portion of the first compressed portion to the receiver inlet; and a bypass valve that includes a bypass valve inlet and a bypass valve outlet, with the bypass valve inlet disposed to receive the second sub-portion of the first compressed portion.

In another aspect combinable with any of the previous aspects, the modulating capacity control circuit includes a mixer that includes a mixer inlet fluidly coupled to the outlet of the bypass valve, and a mixer outlet fluidly coupled to the condenser inlet and the bidirectional port of the absorber/desorber; a quench valve including an inlet coupled to the receiver outlet and an outlet coupled to the receiver outlet; and a suction accumulator including a suction accumulator inlet coupled to the evaporator outlet and a suction accumulator vapor-side outlet coupled to the bidirectional port of the absorber/desorber.

In another aspect combinable with any of the previous aspects, the bypass valve outlet is coupled to the mixer inlet, causing the second sub-portion of the first compressed portion to bypass the evaporator and the suction accumulator.

Another aspect combinable with any of the previous aspects further includes first and second sensors configured to sense thermodynamic properties of the refrigerant fluid at the mixer outlet and directly or indirectly control operation of the quench valve and the bypass valve.

Another aspect combinable with any of the previous aspects further includes a recuperative heat exchanger that includes a first refrigerant path disposed between the receiver outlet and the evaporator inlet, and a second refrigerant path disposed between the vapor-side outlet and the compressor inlet.

Another aspect combinable with any of the previous aspects further includes a liquid separator including a liquid separator inlet, a vapor-side outlet, and a liquid-side outlet, with the vapor-side outlet fluidly coupled to the bidirectional port of the absorber/desorber and the compressor inlet; and an ejector including a primary inlet disposed to receive refrigerant fluid from the receiver outlet, the ejector further including a secondary inlet and an ejector outlet.

Another aspect combinable with any of the previous aspects further includes a liquid separator including a liquid separator inlet, a vapor-side outlet, and a liquid-side outlet; and a pump including a pump inlet disposed to receive refrigerant liquid from the liquid-side outlet and a pump outlet that outputs the refrigerant liquid to the evaporator inlet.

In another aspect combinable with any of the previous aspects, the modulating capacity control circuit is further configured to divert the second sub-portion of the first compressed portion to the evaporator inlet to modulate a cooling capacity demand on the closed-circuit refrigeration system that results at least in part from extraction of the heat from the at least one heat load.

In another aspect combinable with any of the previous aspects, the modulating capacity control circuit further includes an expansion valve including an inlet that receives refrigerant fluid from the receiver outlet and an outlet that transports expanded refrigerant towards the evaporator inlet; and first and second sensors configured to sense thermodynamic properties of the refrigerant fluid at the evaporator outlet to control operation of the expansion valve and the bypass valve.

In another aspect combinable with any of the previous aspects, the closed-circuit refrigeration system includes a heat pump that includes a four-way valve disposed in the closed-circuit fluid path and including first, second, third, and fourth four-way valve ports to fluidly couple the four-way valve with the receiver, the evaporator, the condenser, and the compressor.

Another aspect combinable with any of the previous aspects further includes a suction accumulator that includes a suction accumulator inlet coupled to one of the four-way valve ports, and a suction accumulator vapor-side outlet coupled to the compressor inlet and the bidirectional port of the absorber/desorber.

In another aspect combinable with any of the previous aspects, the heat pump includes a first by-passable expansion valve coupled between the receiver outlet and the evaporator inlet, and a second by-passable expansion valve coupled between the receiver inlet and the condenser outlet.

In another aspect combinable with any of the previous aspects, the first by-passable expansion valve is configured to expand the refrigerant fluid to produce a mixed liquid-vapor refrigerant fluid that flows into the suction accumulator for a cooling mode of operation.

In another aspect combinable with any of the previous aspects, the second by-passable expansion valve is configured to expand the refrigerant fluid to produce a mixed liquid-vapor refrigerant fluid that flows into the condenser for a heating mode of operation.

Another aspect combinable with any of the previous aspects further includes a liquid separator including a liquid separator inlet, a vapor-side outlet, and a liquid-side outlet, the liquid separator inlet coupled to one of the four-way valve ports and the vapor-side outlet coupled to the compressor inlet and the bidirectional port of the absorber/desorber; and an ejector including a primary inlet disposed to receive refrigerant from the receiver, a secondary inlet that receives refrigerant liquid from the liquid-side outlet of the liquid separator, and an ejector outlet that transports refrigerant fluid to the evaporator inlet.

Another aspect combinable with any of the previous aspects further includes a liquid separator including a liquid separator inlet, a vapor-side outlet, and a liquid-side outlet, the liquid separator inlet coupled to one of the four-way valve ports, and the vapor-side outlet coupled to the compressor inlet and the bidirectional port of the absorber/desorber; and a pump including a pump inlet disposed to receive refrigerant liquid from the liquid-side outlet and a pump outlet that outputs pumped refrigerant liquid to the evaporator inlet.

Another aspect combinable with any of the previous aspects further includes a control system configured to control operation of the four-way valve, with the control system controlling the heat pump to operate in a cooling mode to transfer heat from the at least one heat load to the refrigerant fluid or controlling the heat pump to operate in a heating mode to transfer heat to the at least one heat load from the refrigerant fluid.

In another aspect combinable with any of the previous aspects, the closed-circuit refrigeration system includes a vapor compression closed-circuit system that includes the receiver, the at least one evaporator, the compressor, and the condenser; and a closed-circuit system that includes the receiver and a closed-circuit evaporator, the closed-circuit system configured to receive refrigerant fluid from the receiver and transport the refrigerant fluid through the closed-circuit evaporator to cool a high temperature heat load.

In another aspect combinable with any of the previous aspects, the closed-circuit system includes a closed-circuit pumping system that includes a pump disposed to receive refrigerant fluid from the receiver and configured to circulate the refrigerant fluid to an inlet of the closed-circuit evaporator, with the closed-circuit evaporator including an outlet that delivers refrigerant fluid to the condenser inlet.

In another aspect combinable with any of the previous aspects, the compressor includes an economizer port disposed to receive refrigerant fluid from the closed-circuit evaporator.

The above aspects or another of the disclosed aspects may include one or more of the following advantages.

The aspects enable cooling of heat loads by refrigeration systems that are actually sized for a lower load. That is, the rating of a compressor's vapor pumping flow rate capacity is lower than the actual rating that would be required at peak operation of the heat load. Thus, the components of the closed-circuit refrigeration system, e.g., the compressor and the condenser are rated lower than the actual rating required by the heat load. This lower rating of the components means that the components are smaller, lower in weight, and consume less energy than equivalent components that would be rated according to the actual rating required by peak operation of the heat load.

Typically, high load demand occurs during daytime with high ambient temperature. In those instances, the ionic liquid (IL) absorber/desorber operates as a thermal energy storage. Thus, when the heat load is applied to the evaporator and the vapor produced exceeds the design for compressor vapor pumping flow rate capacity, a portion of the vapor formed in the evaporator is induced by the compressor and the remaining portion is absorbed by the IL in the absorber/desorber operating as an absorber.

During lower heat demand when the combination of ambient conditions and heat loads result in a low demand, the heat load applied to the evaporator is below the compressor vapor pumping flow capacity, and as a result, all of the vapor formed in the evaporator is induced by the compressor and, in addition, the compressor induces the vapor desorbed from the IL in the absorber/desorber operating as a desorber.

Under conditions when the compressor processes all vapor formed in the evaporator, the absorber/desorber neither absorbs nor generates any refrigerant vapor. The closed-cycle system components required by the disclosed systems avoid use of maximally sized compressors and condensers to compress the generated vapor and to remove heat from the compressed vapor. In addition, avoiding use of large and heavy compressors and condensers also results in saving of significant amounts of electrical power.

Some of the thermal management systems described herein also include the closed-circuit refrigeration system with the absorber/desorber with reduced sizing of the closed-circuit refrigeration system, while permitting the system to maintain a set temperature of a high heat load within a relatively small tolerance of a temperature set point.

The details of one or more embodiments are set forth in the accompanying drawings and the description below. Other features and advantages will be apparent from the description, drawings, and claims.

### DESCRIPTION OF DRAWINGS

FIGS. 1-8 are schematic diagrams of example implementations of a thermal management system that includes a closed-circuit refrigeration system with an ionic liquid (IL) absorber/desorber according to the present disclosure.

FIGS. 9A-9D are schematic diagrams showing alternative configurations for arrangement of evaporators/loads on the closed-circuit refrigeration systems according to the present disclosure.

FIG. 10 is a block diagram of a control system or controller according to the present disclosure.

FIG. 11 is a schematic diagram of an example of directed energy system that includes a thermal management system according to the present disclosure.

### DETAILED DESCRIPTION

Cooling of large loads and high heat loads that are also highly temperature sensitive can present a number of challenges. Such loads generate significant quantities of heat that is extracted during cooling. In conventional closed-circuit refrigeration systems, cooling high heat loads typically involves circulating refrigerant fluid at a relatively high mass flow rate. Closed-circuit system components that are used for refrigerant fluid circulation—including large compressors to compress vapor at a low pressure to vapor at a high pressure and large condensers to remove heat from the compressed vapor at the high pressure and convert to a liquid are typically heavy and consume significant power. These components are specially sized for ‘worst case conditions.’ As a result, many closed-circuit systems are not well suited for deployment in mobile platforms—such as on small vehicles or in space—where size and weight constraints may make the use of overly large compressors and condensers impractical.

In particular, heating, ventilation, air conditioning, and refrigeration systems conventionally may be sized for an anticipated highest load on a hot day, but which are the conditions may not frequently happen, resulting in oversized system components with excessive dimensions and weight.

The examples discussed below use a refrigeration system that is sized for a reduced heat load, with an ionic liquid (TL) absorber/desorber that operates as a storage for excessive refrigerant vapor that is discharged from the evaporator when excessive heat load is applied. The IL absorber/desorber is configured to match a heat load gap when an applied heat load exceeds a compressor pumping capability.

An ionic liquid (IL) is a salt that is in a liquid state. Ordinary liquids such as water and gasoline are predominantly electrically neutral molecules, whereas ionic liquids are composed of ions and short-lived ion pairs. An ionic liquid (IL) absorber/desorber is a device that houses an ionic liquid (TL). The IL absorber/desorber absorbs excess vapor when the vapor produced by the evaporator exceeds the vapor compression capacity of the compressor, and desorbs vapor when the vapor compression capacity of the compressor exceeds the vapor produced by the evaporator. One of the properties of ionic liquids is an absence of vapor pressure. During desorption of refrigerant, such as ammonia from water, water releases a mixture of ammonia and water vapor. An additional rectifier is needed to separate ammonia vapor from water vapor. During desorption of ammonia from an IL, ammonia vapor only is released since the TL does not have vapor pressure. Thus the refrigerant vapor can be compressed, condensed, and returned to the receiver at a desired rate with no additional rectification.

An IL absorber/desorber can be selected or designed to provide the best fit for each particular application. One alternative to an IL material is a solid that absorbs ammonia vapor. However, solids require significant cooling during absorption and significant heat input during desorption. IL liquids may absorb and desorb ammonia in adiabatic conditions which reduces dimensions and weight of absorption/desorption. However, absorption with cooling and desorption with heating is more effective than adiabatic absorption and desorption. If a thermal management system stores thermal energy to satisfy a future peak demand, the IL absorber stores the refrigerant after the peak demand has been satisfied.

Some temperature sensitive loads such as electronic components and devices may require temperature regulation within a relatively narrow range of operating temperatures. Maintaining the temperature of such a load to within a small tolerance of a temperature set point can be challenging when a single-phase refrigerant fluid is used for heat extraction, since the refrigerant fluid itself will increase in temperature as heat is absorbed from the heat load.

Directed energy systems that are mounted to mobile vehicles, such as trucks, or that exist in space may present many of the foregoing operating challenges, as such systems may include high heat loads and temperature sensitive components that require precise cooling during operation in a relatively short time. The thermal management systems disclosed herein, while generally applicable to the cooling of a wide variety of heat loads, are particularly well suited for operation with such directed energy systems.

In some cases, a thermal management system (TMS) may be specified to cool two different kinds of heat loads—high heat loads (high heat and/or highly temperature sensitive components) operative for short periods of time and low heat loads (relative to the high heat loads) operative continuously or for relatively long periods (relative to the high heat loads). However, to specify a refrigeration system for the high heat load may result in a relatively large and heavy refrigeration system with a concomitant need for a large and heavy power system to sustain operation of the refrigeration system.

The thermal management systems and methods disclosed herein include the IL absorber/desorber that can reduce both overall size and weight relative to a conventional refrigeration system that is sized for maximum heat loading characteristics. The disclosed thermal management systems that use the IL absorber/desorber would, in general, require lighter compressors and condensers and use less power than the conventional closed-circuitry systems without the IL absorber/desorber for a given amount of refrigeration over specified periods of operation. With the IL absorber/desorber, the thermal management systems may be sized for the low loads and the IL absorber/desorber can be sized for excessive amount refrigerant generated by the evaporator operating at the high loads for short periods of time.

Throughout the application, inlet and outlet sides of the various instantiations of the evaporator and other components are denoted by legends “inlet” and “outlet.” In general, fluid flow is explicitly understood from these instantiations as well as arrows appearing on conduits coupling the various components, as illustrated in the figures. Also, generally in the figures, solid lines generally depict items, e.g., conduits, which carry fluid whereas dashed lines depict control/sensor lines.

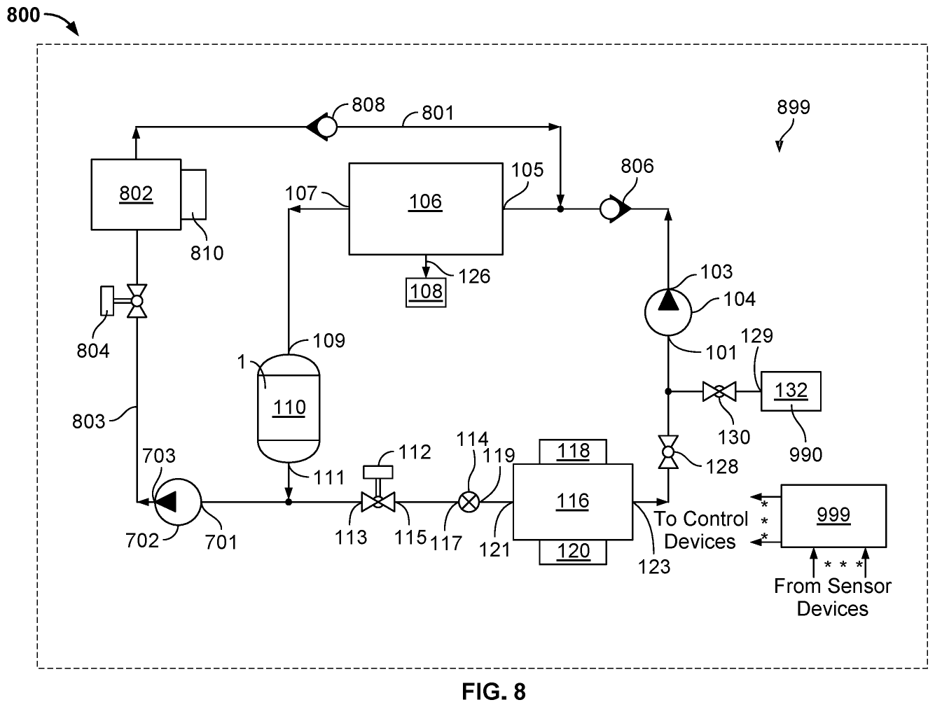

In addition, there are three example types of heat loads discussed herein. The first is a low heat load (e.g., low heat load 120 shown in the figures), the second is a high heat load (e.g., high heat load 118 shown in the figures), and the third is a high temperature heat load (e.g., high temperature heat load 810 shown in FIG. 8). Low heat loads are heat loads that operate over long (or continuous) time intervals and are cooled by closed-circuit refrigeration systems with refrigerant that is substantially below the condensation temperature of the refrigerant vapor. High heat loads are heat loads that operate over short time intervals of time relative to the operating interval of the low heat loads, generate significantly additional amounts of heat, relative to the low heat load, and are cooled generally with refrigerant that is substantially below the condensation temperature of the refrigerant vapor. A high temperature heat load is a heat load that can be cooled by a closed-circuit pumping circuit of a closed-circuit refrigeration system. A high temperature heat load is cooled at a high temperature that is equal to or above the condensation temperature of the refrigerant vapor.

In some aspects, “refrigeration” as used in the present disclosure can mean a system (or multiple systems fluidly coupled) that operates to generate a purposeful change of a characteristic of a coolant (e.g., a refrigerant fluid) to effectuate or increase heat transfer between two mediums (one of which can be the coolant). The purposeful change of the characteristic can be, for example, a change in pressure (e.g., depressurization) of a pressurized coolant though an expansion valve. In some embodiments, the change in pressure can include a phase change of the coolant, such as a liquid-to-gas phase change (e.g., endothermic vaporization). In some embodiments, pressurization of the refrigerant can be performed by a powered (e.g., electrically or otherwise) component, such as (but not limited to) a compressor. In some embodiments, pressurization can be performed as part of the refrigeration cycle (e.g., a closed-cycle refrigeration process in which gaseous refrigerant is substantially or completely recycled and compressed into a liquid state) or prior to use (e.g., storing pre-compressed liquid refrigerant for later use in an open-cycle refrigeration process in which a reserve of liquid refrigerant is used but substantially not recycled). In some embodiments, the phase change can be driven by heating a liquid refrigerant with a very low boiling point (e.g., ammonia as used in an absorption-type refrigeration cycle).

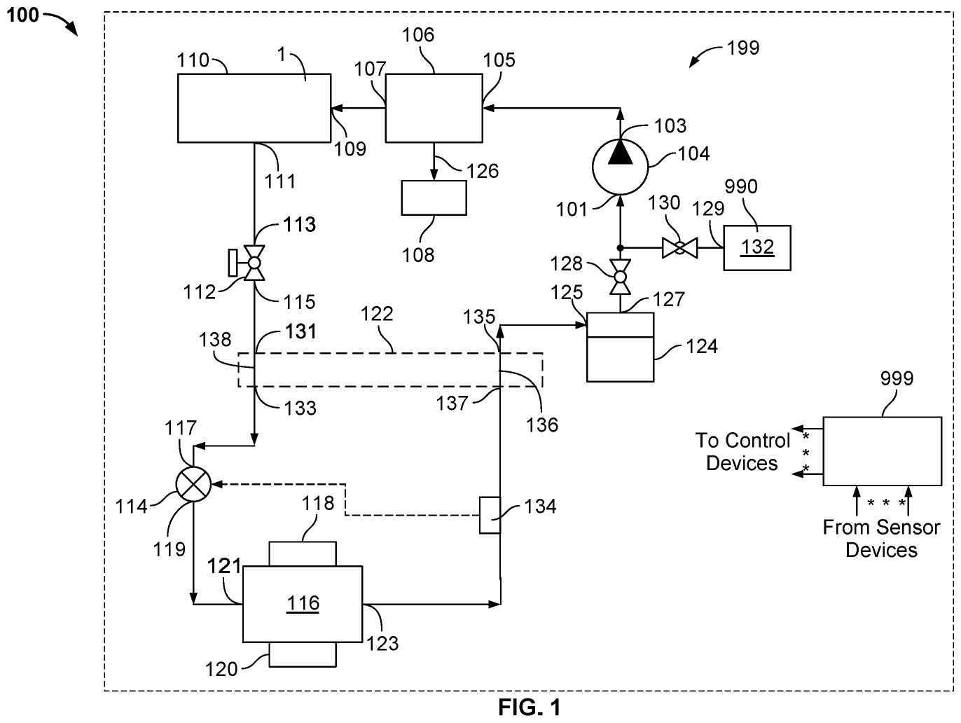

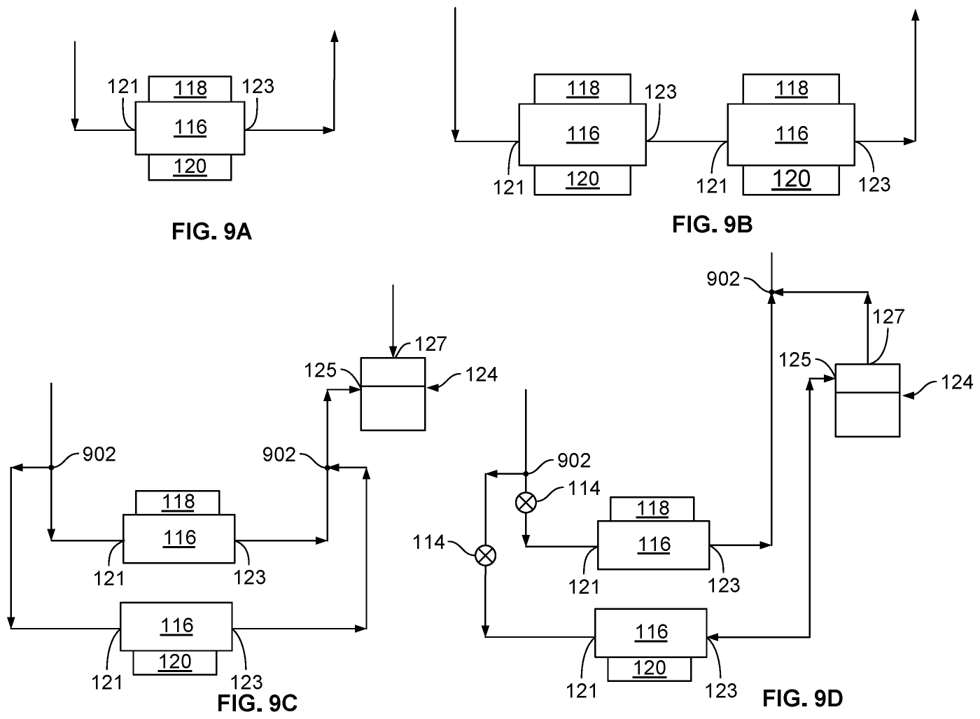

Referring to FIG. 1, an example of a thermal management system (TMS) 100 that includes a closed-circuit refrigeration system (CCRS) 199 is shown. TMS 100 provides closed-circuit refrigeration for low heat loads over long time intervals. The CCRS 199 (and the other CCRS implementations described herein) has a closed-circuit refrigerant fluid path that includes a receiver 110 that includes a receiver inlet 109 and a receiver outlet 111 and stores refrigerant fluid 1, an optional solenoid control valve 112 having an inlet 113 and an outlet 115, an expansion control device 114 (e.g., an expansion valve (EV) 114 that may or may not be an electrically controlled expansion valve) having an expansion valve inlet 117 and an expansion valve outlet 119, an evaporator 116 (with example implementations shown in FIGS. 9A-9D), an optional suction accumulator 124 (when two ports are used) having an inlet 125 and a vapor-side outlet 127. (As described below, the suction accumulator 124 may be replaced by a liquid separator 124 when three ports are used, e.g., having a liquid separator inlet 125, a vapor-side outlet 127, and a liquid-side outlet 207). Other conventional details such as membranes, coalescing filters, or meshes, etc. are not shown. Also not shown is an optional orifice coupled between a liquid-side outlet (when used as a liquid separator) and an oil return line or path.

Receiver 110 can also include an optional pressure relief valve. To charge receiver 110, refrigerant fluid (labeled “1” in FIG. 1 and understood to also be present in the other example CCRS implementations described herein) is typically introduced into receiver 110 via the inlet 109, and this can be done, for example, at service locations. Operating in the field the refrigerant exits receiver 110 through outlet 111 that is connected to conduit. In case of emergency, if the fluid pressure within receiver 110 exceeds a pressure limit value, a pressure relief valve opens to allow a portion of the refrigerant fluid to escape through the pressure relief valve to reduce the fluid pressure within receiver 110. Receiver 110 is typically implemented as an insulated vessel that stores a refrigerant fluid at relatively high pressure. Receiver 110 can also include insulation (not shown) applied around the receiver 110 to reduce thermal losses.

In general, receiver 110 can have a variety of different shapes. In some embodiments, for example, the receiver 110 is cylindrical. Examples of other possible shapes include, but are not limited to, rectangular prismatic, cubic, and conical. In certain embodiments, receiver 110 can be oriented such that outlet 111 is positioned at the bottom of the receiver 110. In this manner, the liquid portion of the refrigerant fluid within receiver 110 is discharged first through outlet 111, prior to discharge of refrigerant vapor. In certain embodiments, the refrigerant fluid can be an ammonia-based mixture that includes ammonia and one or more other substances. For example, mixtures can include one or more additives that facilitate ammonia absorption or ammonia burning.

The CCRS 199 also includes a compressor 104 having a compressor inlet 101 and a compressor outlet 103, a condenser 106 having a condenser inlet 105 and a condenser outlet 107, an optional solenoid control valve 128, and an absorber/desorber 132, having a bidirectional port 129, all of which are coupled via conduit. The optional solenoid control valve 128 can be used when the expansion valve 114 is not configured to completely stop refrigerant flow when the TMS 100 is in an off state. The absorber/desorber 132, in this example, is an ionic liquid (IL) absorber/desorber 132. The absorber/desorber 132 includes a housing containing an ionic liquid store (that stores an ionic liquid (IL) 990). The bidirectional port 129 is provided in the housing to enable input and output of refrigerant vapor. During the absorption case, the TL 990 temperature increases which reduces the IL 990 capability to absorb refrigerant. Conversely, during the desorption case, the IL 990 temperature decreases which reduces the TL 990 capability to desorb refrigerant. Both the absorption and desorption processes can be improved if the absorption process is accompanied by cooling the TL 990 and the desorption process is accompanied by heating the IL 990.

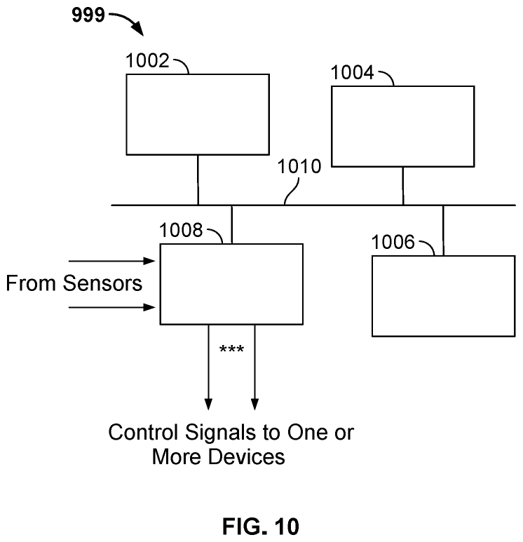

The CCRS 199, as all disclosed embodiments, may also include a control system (or controller) 999 (see FIG. 10 for an exemplary embodiment) that produces control signals (based on sensed thermodynamic properties) to control operation of one or more of the various devices, e.g., optional solenoid control valve 112, expansion valve 114, etc., as needed, as well as to control operation of a motor of the compressor 104, a fan 108. Control system 999 may receive signals, process received signals and send signals (as appropriate) from/to the sensors and control devices to operate the TMS 100.

The term “control system,” as used herein, can refer to an overall system that provides control signals and receives feedback data from unit controllers, such as unit controllers (e.g., programmable logic controllers, motor controllers, variable frequency drives, actuators). In some aspects, the control system includes the overall system and the unit controllers. In some aspects, a control system simply refers to as a single unit controller or a network of two or more individual unit controllers that communicate directly with each other (rather than with an overall system.

The process streams (e.g., refrigerant flows, ambient airflows, other heat exchange fluid flows) in a TMS according to the present disclosure, as well as process streams within any downstream processes with which the TMS is fluidly coupled, can be flowed using one or more flow control systems (e.g., that include the control system 999) implemented throughout the system. A flow control system can include one or more flow pumps, fans, blowers, or solids conveyors to move the process streams, one or more flow pipes through which the process streams are flowed and one or more valves to regulate the flow of streams through the pipes, whether shown in the exemplary figures or not. Each of the configurations described herein can include at least one variable frequency drive (VFD) coupled to a respective pump or fan that is capable of controlling at least one fluid flow rate. In some implementations, liquid flow rates are controlled by at least one flow control valve.

In some embodiments, a flow control system can be operated manually. For example, an operator can set a flow rate for each pump or transfer device and set valve open or close positions to regulate the flow of the process streams through the pipes in the flow control system. Once the operator has set the flow rates and the valve open or close positions for all flow control systems distributed across the system, the flow control system can flow the streams under constant flow conditions, for example, constant volumetric rate or other flow conditions. To change the flow conditions, the operator can manually operate the flow control system, for example, by changing the pump flow rate or the valve open or close position.

In some embodiments, a flow control system can be operated automatically. For example, the flow control system can be connected to a computer or control system (e.g., control system 999) to operate the flow control system. The control system can include a computer-readable medium storing instructions (such as flow control instructions and other instructions) executable by one or more processors to perform operations (such as flow control operations). An operator can set the flow rates and the valve open or close positions for all flow control systems distributed across the facility using the control system. In such embodiments, the operator can manually change the flow conditions by providing inputs through the control system. Also, in such embodiments, the control system can automatically (that is, without manual intervention) control one or more of the flow control systems, for example, using feedback systems connected to the control system. For example, a sensor (such as a pressure sensor, temperature sensor or other sensor) can be connected to a pipe through which a fluid flows. The sensor can monitor and provide a flow condition (such as a pressure, temperature, or other flow condition) of the process stream to the control system. In response to the flow condition exceeding a threshold (such as a threshold pressure value, a threshold temperature value, or other threshold value), the control system can automatically perform operations. For example, if the pressure or temperature in the pipe exceeds the threshold pressure value or the threshold temperature value, respectively, the control system can provide a signal to the pump to decrease a flow rate, a signal to open a valve to relieve the pressure, a signal to shut down process stream flow, or other signals.

The evaporator 116 can be implemented in a variety of ways. In general, evaporator 116 functions as a heat exchanger, providing thermal contact between the refrigerant fluid and heat loads 120, 118. Typically, evaporator 116 includes one or more flow channels extending internally between an inlet 121 and an outlet 123 of the evaporator 116, allowing refrigerant fluid to flow through the evaporator 116 and absorb heat from heat load(s) 120, 118. A variety of different evaporators can be used in TMS 100 (and other example implementations herein). In general, any cold plate may function as the evaporator 116. Evaporator 116 can accommodate any type of refrigerant fluid channels (including mini/micro-channel tubes), blocks of printed circuit heat exchanging structures, or more generally, any heat exchanging structures that are used to transport single-phase or two-phase fluids. The evaporator 116 and/or components thereof, such as refrigerant fluid channels, can be attached to the heat loads 120, 118 mechanically, or can be welded, brazed, or bonded to the heat load in any manner.

In some embodiments, evaporator 116 (or certain components thereof) can be fabricated as part of heat loads 120, 118 or otherwise integrated into one or more of the heat loads 120, 118. For example, a portion of high heat load 118 with refrigerant fluid channels can effectively function as the evaporator 116. The evaporator 116 can be implemented as a plurality of evaporators connected in parallel and/or in series or as individual evaporators.

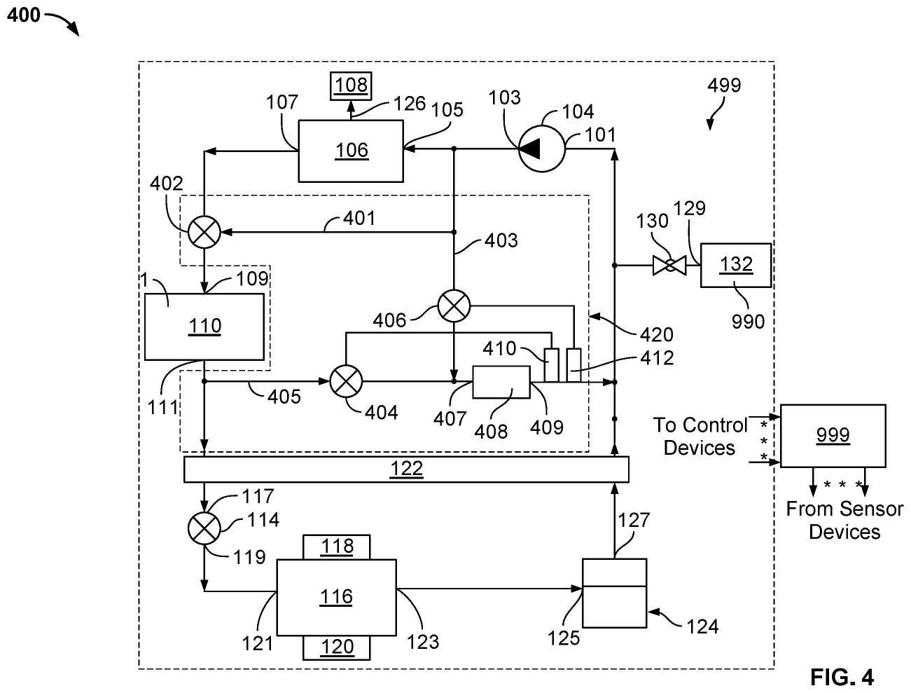

As shown in FIG. 1, the TMS 100 can include an optional recuperative heat exchanger 122 (also shown optionally in FIG. 4) fluidly coupled at an inlet 131 to the valve outlet 115 (to form a first fluid path 138) and at an inlet 137 to the evaporator outlet 123 (to form a second fluid path 136). The heat exchanger 122 is also fluidly coupled at an outlet 133 to the valve inlet 117 and at another outlet 135 to the accumulator inlet 125. In examples of the TMS that do not include the recuperative heat exchanger 122, the valve outlet 115 can be directly fluidly coupled to the valve inlet 117, and the evaporator outlet 123 can be directly fluidly coupled to the accumulator inlet 125.

As used herein, the compressor 104, in general, is a device that increases the pressure of a gas by reducing the gas volume. Usually, the term compressor refers to devices operating at and above ambient pressure, (some refrigerant compressors may operate inducing refrigerant at pressures below ambient pressure, e.g., desalination vapor compression systems employ compressors with suction and discharge pressures below ambient pressure). While in the CCRS 199, the compressor 104 consumes power and the discharge pressure can be lower than the discharge pressure of an equivalent CCRS to handle both heat loads 120, 118 and, therefore, the power consumed by the compressor 104 can be less than the power consumed by a compressor of the equivalent closed-circuit refrigerant system.

In general, the optional solenoid control valves 128 and 130 (as well as solenoid control valve 112) include a solenoid that uses an electric current to generate a magnetic field to control a mechanism that regulates an opening in a valve to control fluid flow. The optional solenoid control valves 128 and/or 130, for instance, are configurable to stop refrigerant flow as an on/off valve, if the expansion valve 114 cannot shut off fluid flow robustly.

Expansion valve 114 functions as a flow control valve and in particular as a refrigerant expansion valve. In general, expansion valve 114 can be implemented as any one or more of a variety of different mechanical and/or electronic devices. For example, in some embodiments, expansion valve 114 can be implemented as a fixed orifice, a capillary tube, and/or a mechanical or electronic expansion valve. In general, fixed orifices and capillary tubes are passive flow restriction elements which do not actively regulate refrigerant fluid flow. Typically, electrically controlled expansion valves 114 include an orifice, a moving seat, a motor or actuator that changes the position of the seat with respect to the orifice, a controller, and pressure and temperature sensors at the evaporator outlet 123, such as sensor 134.

Mechanical expansion valves (usually called thermostatic or thermal expansion valves) are typically flow control devices that enthalpically expand a refrigerant fluid from a first pressure to an evaporating pressure, controlling the superheat at the evaporator outlet. Mechanical expansion valves generally include an orifice, a moving seat that changes the cross-sectional area of the orifice and the refrigerant fluid volume and mass flow rates, a diaphragm moving the seat, and a bulb at the evaporator outlet. The bulb is charged with a fluid and it hermetically, fluidly communicates with a chamber above the diaphragm. The bulb senses the refrigerant fluid temperature at the evaporator outlet (or another location) and the pressure of the fluid inside the bulb transfers the pressure in the bulb through the chamber to the diaphragm and moves the diaphragm and the seat to close or to open the orifice. Examples of suitable commercially available expansion valves that can function as expansion valve 114 include, but are not limited to, thermostatic expansion valves available from the Sporlan Division of Parker Hannifin Corporation (Washington, Mo.) and from Danfoss (Syddanmark, Denmark).

The controller 999, generally, calculates the superheat for the expanded refrigerant fluid based on pressure and temperature measurements at the evaporator outlet. If the superheat is above a set-point value, the seat moves to increase the cross-sectional area and the refrigerant fluid volume and mass flow rates to match the superheat set-point value. If the superheat is below the set-point value the seat moves to decrease the cross-sectional area and the refrigerant fluid flow rates. The controller 999 may be configured to control vapor quality at the evaporator outlet as disclosed below.

The TMS 100, and more specifically the CCRS 199, can operate in a closed-circuit refrigeration configuration. In this configuration, circulating refrigerant enters the compressor 104 as a saturated or superheated vapor and is compressed to a higher pressure at a higher temperature (a superheated vapor). This superheated vapor is at a temperature and pressure at which it can be condensed in the condenser 106 by either cooling water 126 or cooling air 126 (i.e., condenser fluid 126) flowing across a coil or tubes in the condenser 106 by a fluid circulator 108 (e.g., a pump 108 in the case of condenser water or a fan 108 in the case of condenser air). At the condenser 106, the circulating refrigerant loses heat and thus removes heat from the TMS 100, which removed heat is carried away by either the water or air (whichever may be the case) flowing over coil or tubes in the condenser 106, providing a condensed liquid refrigerant.

The condensed and sub-cooled liquid refrigerant is routed into the receiver 110, exits the receiver 110, and enters the expansion valve 114 through the optional solenoid control valve 112. The refrigerant is enthalpically expanded in the expansion valve 114 and the high pressure sub-cooled liquid refrigerant turns into liquid-vapor mixture at a low pressure and temperature. The temperature of the liquid and vapor refrigerant mixture (evaporating temperature) is lower than the temperature of the low heat load 120. The mixture is routed through a coil or tubes in the evaporator 116. The heat from the low heat load 120, in thermally conductive and/or convective contact with or proximate to the evaporator 116, partially or completely evaporates the liquid portion of the two-phase refrigerant mixture, and may superheat the mixture.

When the electrically controlled expansion valve 114 is used, the state of the refrigerant fluid leaving the evaporator 116 is sensed by a sensor 134 disposed at the outlet 123 of the evaporator 116. The sensor 134 produces a signal that either directly or indirectly (via a controller 999) controls operation of the expansion valve 114. The refrigerant leaves the evaporator 116 and enters the suction accumulator 124.

The saturated or superheated vapor exits the suction accumulator 124 and enters the compressor 104. The compressor 104 compresses the saturated or superheated vapor to a higher pressure at a higher temperature (the superheated vapor), completing the cycle.

The evaporator 116 is where the circulating refrigerant absorbs and removes heat from the applied low heat load 120 and high heat load 118 (also in thermal conductive and/or convective contact with the evaporator 116) which heat is subsequently rejected in the condenser 106 and transferred to an ambient by water or air used in the condenser 106.

During operation of the CCRS 199, the absorber/desorber 132 (with or without the optional solenoid control valves 128, 130), can operate according to one of three modes, as follows, without the optional recuperative heat exchanger 122. In an example first mode, the heat load operates in long periods comparable with the cooling capacity of the CCRS 199. In the first mode, when the heat load 120 and/or 118 correspond to compressor pumping capacity, compressor 104 processes all vapor formed in the evaporator 116. The absorber/desorber 132 neither absorbs nor generates any significant amount of refrigerant vapor. Thus, in this case the optional solenoid control valve 130 may stay closed.

In an example second mode, the high heat load operates in short periods and exceeds the cooling capacity of the CCRS 199. In the second mode, when the low heat load 120 and/or high heat load 118 exceed the compressor flow pumping capacity, a portion of vapor formed in the evaporator 116 is induced by the compressor 104. The remaining portion is absorbed by the IL 990 in the absorber/desorber 132 operating as an absorber. When the heat on heat loads 120, 118 increases, the superheat generated at the evaporator outlet 123 increases as well. In response, the expansion valve 114 increases the orifice opening and the flow rate through the evaporator 116 to satisfy the increased heat load and the increased superheat. When the flow rate exceeds the compressor pumping capacity, the evaporating and suction pressures concomitantly increase, destroying the refrigerant vapor—ionic liquid equilibrium. The excessive amount of formed refrigerant vapor at the outlet of the evaporator 116 is absorbed by the IL in the absorber/desorber 132 until the equilibrium is re-established at the increased evaporating pressure. The receiver 110 is sized to sustain the increased refrigerant mass flow rate demand in this case. In this case the optional solenoid control valve 130 generally remains open. In general expansion valves regulate liquid feeding evaporators sensing the superheat.

In example third mode of operation, the heat load is reduced or negligible. When the heat from heat loads 120 and/or 118 on the evaporator 116 decreases, the superheat at the evaporator outlet 123 decreases as well. In response, the expansion valve 114 decreases the orifice opening (based on sensor 134) and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor that was desorbed from the absorber/desorber 132 into the receiver 110, via condenser 106, until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator 116. If the heat loading is small, the additional optional solenoid control valve 128 may be open to allow circulation of the evaporator 116 to cool the heat loads.

In the example of FIG. 1 (and other example implementations as appropriate), the absorber/desorber 132 can operate as an alternative to an open-circuit refrigeration system. The absorber/desorber 132 can operate as a thermal energy store. Also, the IL absorber/desorber 132 can be configured to operate as a supplemental thermal management to an open-circuit refrigeration system. The alternative can operate completely independently, in parallel, or in a sequence. Liquid agitation may improve the absorption and desorption rates. Traditional agitation means can be built-in into the IL absorber/desorber, such as sparging or steering devices, eductors, e.g., ejectors, etc.

In the example implementations of TMS 100 that include the recuperative heat exchanger 122, the evaporator 116 can provide for a lower vapor quality at the evaporator outlet 123 because of the presence of the recuperative heat exchanger 122 that evaporates any remaining liquid prior to being fed to the inlet of the compressor 104. In some implementations, the presence of the recuperative heat exchanger 122 can eliminate the need for the suction accumulator 124. As shown, the recuperative heat exchanger 122 is coupled in a first refrigerant path between the receiver 110 and the electrically controlled expansion valve 114 and in a second refrigerant path from evaporator outlet 123 to accumulator inlet 125. The recuperative heat exchanger 122 transfers heat energy from the refrigerant fluid passing to suction accumulator 124 to refrigerant fluid upstream from the expansion valve 114. Inclusion of the recuperative heat exchanger 122 can reduce mass flow rate demand and allows operation of evaporator 116 within threshold of vapor quality. In some examples, the recuperative heat exchanger 122 transfers heat energy from the refrigerant fluid emerging from evaporator 116, and the suction accumulator 26 is not needed. That is, the recuperative heat exchanger 122 can obviate the need for the suction accumulator 124. The absorber/desorber 132 (with the optional solenoid control valve 130) along with the recuperative heat exchanger 122 can operates in several example modes as follows.

In a first example mode of operation, the low heat load 120 and/or high heat load 118 correspond to compressor pumping capacity, and compressor 104 processes all vapor formed in the evaporator 116. The absorber/desorber 132 neither absorbs nor generates any refrigerant vapor. In a second example mode of operation, the low heat load 120 and/or the high heat load 118 exceeds the compressor flow pumping capacity, and a portion of vapor formed in the evaporator 116 is induced by the compressor 104. The remaining portion is absorbed by the IL 990 in the absorber/desorber 132 operating as an absorber.

In a third example mode of operation, the low heat load 120 and/or high heat load 118 on the evaporator 116 decreases, and the superheat at the evaporator outlet 123 decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor that was desorbed from the absorber/desorber 132 into the receiver 110 until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator. If the heat loading is small, the additional optional solenoid control valve 128 may be open to allow circulation of the evaporator to cool the heat loads.

The vapor quality of the refrigerant fluid after passing through evaporator 116 can be controlled either directly or indirectly with respect to a vapor quality set point by the controller 999. The evaporator 116 may be configured to maintain exit vapor quality substantially below the critical vapor quality defined as “1,” especially when a recuperative heat exchanger 122 is employed (e.g., recuperative heat exchanger 122 is generally applicable to all embodiments).

Vapor quality is the ratio of mass of vapor to mass of liquid+vapor and is generally kept in a range of approximately 0.5 to almost 1.0; more specifically 0.6 to 0.95; more specifically 0.75 to 0.9 more specifically 0.8 to 0.9 or more specifically about 0.8 to 0.85. “Vapor quality” is thus defined as mass of vapor/total mass (vapor+liquid). In this sense, vapor quality cannot exceed “1” or be equal to a value less than “0.” In practice vapor quality may be expressed as “equilibrium thermodynamic quality” that is calculated as follows:

X=(h−h′)/(h″−h′),

where h is specific enthalpy, specific entropy or specific volume, h′ is of saturated liquid and ″ is of saturated vapor. In this case X can be mathematically below 0 or above 1, unless the calculation process is forced to operate differently. Either approach is acceptable.

During operation of the TMS 100, cooling can be initiated by a variety of different mechanisms. In some embodiments, for example, TMS 100 includes temperature sensors attached to heat loads 120-118 (as will be discussed subsequently). When the temperature of heat loads 120-118 exceeds a certain temperature set point (i.e., threshold value), the controller 999 connected to the temperature sensor can initiate cooling of heat loads 120-118.

Upon initiation of a cooling operation, refrigerant fluid from receiver 110 is discharged from receiver outlet 111, through optional solenoid control valve 112, if present, and is transported through conduit to expansion valve 114, which directly or indirectly controls vapor quality (or superheat) at the evaporator outlet. It should be understood that, more generally, expansion valve 114 can be implemented as any component or device that performs the functional steps described below and provides for vapor quality control (or superheat) at the evaporator outlet.

Once inside the expansion valve 114, the refrigerant fluid undergoes constant enthalpy expansion from an initial pressure pᵣ (i.e., the receiver pressure) to an evaporation pressure pₑ at the outlet 119 of the expansion valve 114. In general, the evaporation pressure pₑ depends on a variety of factors, e.g., the desired temperature set point value (i.e., the target temperature) at which heat loads 120-118 is/are to be maintained and the heat input generated by the respective heat loads. Set points will be discussed below.

The initial pressure in the receiver 110 tends to be in equilibrium with the surrounding temperature and is different for different refrigerants. (Operational conditions of the compressor 104 and condenser 106 may be configured to maintain a higher condensing pressure.) The pressure in the evaporator 116 depends on the evaporating temperature, which is lower than the heat load temperature and is defined during design of the TMS 100. The TMS 100 is operational as long as the receiver-to-evaporator pressure difference is sufficient to drive adequate refrigerant fluid flow through the expansion valve 114. After undergoing constant enthalpy expansion in the expansion valve 114, the liquid refrigerant fluid is converted to a mixture of liquid and vapor phases at the temperature of the fluid and evaporation pressure pₑ. The two-phase refrigerant fluid mixture is transported via conduit to evaporator 116.

When the two-phase mixture of refrigerant fluid is directed into evaporator 116, the liquid phase absorbs heat from heat loads 120 and/or 118, driving a phase transition of the liquid refrigerant fluid into the vapor phase. Because this phase transition occurs at (nominally) constant temperature, the temperature of the refrigerant fluid mixture within evaporator 116 remains unchanged, provided at least some liquid refrigerant fluid remains in evaporator 116 to absorb heat.

Further, the constant temperature of the refrigerant fluid mixture within evaporator 116 can be controlled by adjusting the pressure pₑ of the refrigerant fluid, since adjustment of pₑ changes the boiling temperature of the refrigerant fluid. Thus, by regulating the refrigerant fluid pressure pₑ upstream from evaporator 116, the temperature of the refrigerant fluid within evaporator 116 (and, nominally, the temperature of heat load 118) can be controlled to match a specific temperature set-point value for heat load 118, ensuring that heat loads 120-118 are maintained at, or very near, a target temperature.

The pressure drop across the evaporator 116 causes drop of the temperature of the refrigerant mixture (which is the evaporating temperature), but still the evaporator 116 can be configured to maintain the heat load temperature within the set tolerances.

In some embodiments, for example, the evaporation pressure of the refrigerant fluid can be adjusted via compressor 104 to ensure that the temperature of heat loads 120-118 is maintained to within ±5 degrees C. (e.g., to within ±4 degrees C., to within ±3 degrees C., to within ±2 degrees C., to within ±1 degree C.) of the temperature set point value for, e.g., heat load 118.

As discussed above, within evaporator 116 a portion of the liquid refrigerant in the two-phase refrigerant fluid mixture is converted to refrigerant vapor by undergoing a phase change. As a result, the refrigerant fluid mixture that emerges from evaporator 116 has a higher vapor quality (i.e., the fraction of the vapor phase that exists in refrigerant fluid mixture) than the refrigerant fluid mixture that enters evaporator 116.

As the refrigerant fluid mixture emerges from evaporator 116, a portion of the refrigerant fluid can optionally be used to cool one or more additional heat loads. Typically, for example, the refrigerant fluid that emerges from evaporator 116 is nearly in the vapor phase. The refrigerant fluid vapor (or, more precisely, high vapor quality fluid vapor) can be directed into a heat exchanger coupled to another heat load, and can absorb heat from the additional heat load during propagation through the heat exchanger.

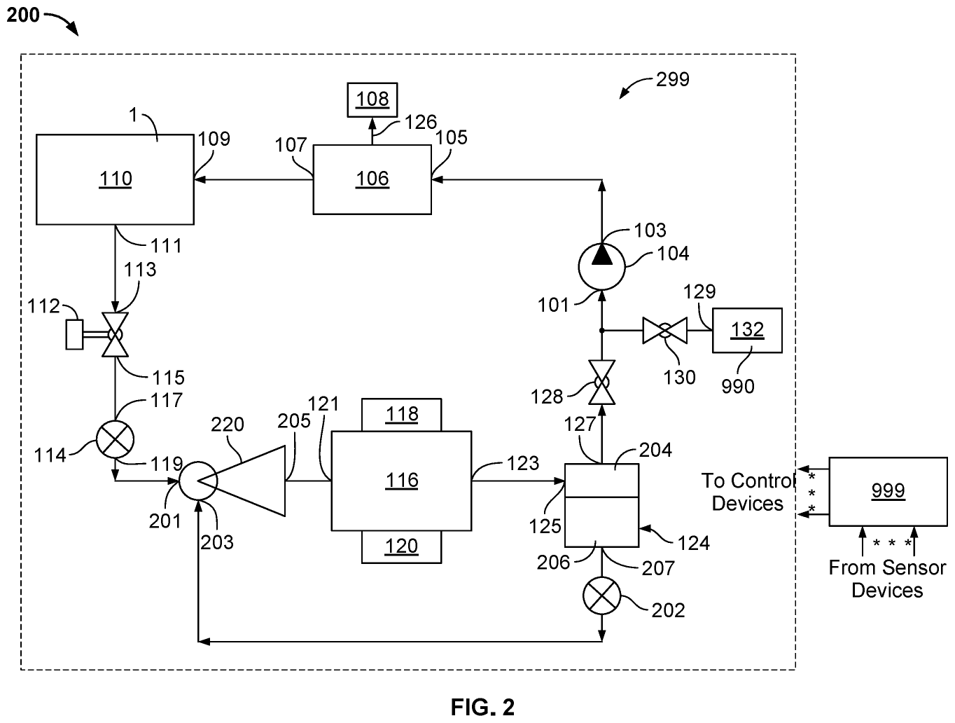

FIG. 2 shows another schematic diagram of an example implementation of a thermal management system (TMS) 200 that includes a CCRS 299 with the IL 990 in absorber/desorber 132 along with an ejector assisted configuration with ejector 220. The use of an ejector can assist in reducing a power requirement of the TMS 200. Items illustrated and referenced, but not mentioned in the discussion below, are discussed and referenced in FIG. 1.

The TMS 200 includes CCRS 299, which includes the receiver 110 configured to store sub-cooled liquid refrigerant, as discussed above but includes an ejector loop with ejector 220. CCRS 299 may include the optional solenoid control valve 112 and the expansion valve 114. The CCRS 299 includes the evaporator 116 having an inlet 121 coupled to an ejector outlet 205 of the ejector 220. The evaporator 116 is coupled between the ejector outlet 205 and the inlet 125 to a liquid separator 124. The ejector 220 has a primary or suction inlet 201 (or high-pressure inlet) that is coupled to the receiver 110 (either directly or through the optional solenoid control valve 112 and/or expansion valve 114). The ejector 220 also has a secondary or motive inlet 203 (or low-pressure inlet) coupled to an outlet of an optional expansion valve 202. The inlet of the optional expansion valve 202 is coupled to a liquid-side outlet 207 of the liquid separator 124, which in addition has an liquid separator inlet 125, a vapor-side outlet 127, a vapor section 204, and a liquid section 206. The alternative CCRS 299 has the closed circuit fluid path.

In CCRS 299, the second optional expansion valve 202 is coupled between the liquid-side port 207 of the liquid separator 124 and the suction or secondary inlet 203 of the ejector 220. The CCRS 299 also includes the absorber/desorber 132 and optional solenoid control valve 130, as discussed above.

The heat loads 120-118 are coupled to the evaporator 116. The evaporator 116 is configured to extract heat from the heat loads 120-118 that are in proximity to or in contact with the evaporator 116. Conduit generally couples the various aforementioned items as shown.

Various combinations of the sensors can be used to measure thermodynamic properties of the TMS 100 that are used to adjust the control devices or pumps discussed above and which signals are processed by the controller 999. Connections (wired or wireless) are provided between each of the sensors and controller 999. In many embodiments, system includes only certain combinations of the sensors (e.g., one, two, three, or four of the sensors) to provide suitable signals for the control devices.

In CCRS 299, the recirculation rate is equal to the vapor quality at the evaporator outlet. The second optional expansion valve 202 is optional and, when used, is a fixed orifice device. The expansion valve 114 (or other control device) can be built in the motive nozzle of the ejector 220 and provides active control of the thermodynamic parameters of refrigerant state at the evaporator outlet. This embodiment of the CCRS 299 can operate as follows:

Refrigerant from the receiver 110 is directed into the ejector 220 (optionally through optional solenoid control valve 112) and expansion valve 114 and expands at a constant entropy in the ejector 220 (in an ideal case; in reality the nozzle is characterized by the ejector isentropic efficiency), and turns into a two-phase (gas/liquid) state. The refrigerant in the two-phase state enters the evaporator 116 that provides cooling duty (to heat loads 120, 118) and discharges the refrigerant in a two-phase state at an exit vapor quality (fraction of vapor to liquid) below a unit vapor quality (“1”). The discharged refrigerant is fed to the liquid separator inlet 125, where the liquid separator 124 separates the discharge refrigerant with only or substantially only liquid exiting the liquid separator 124 at the liquid-side outlet 207 and only or substantially only vapor exiting the liquid separator 124 at outlet 127. The vapor-side may contain some liquid droplets since the liquid separator 124 has a separation efficiency below a “unit” separation. The liquid stream exiting at the liquid-side outlet 207 enters and is expanded in the second expansion valve 202, if used, into a liquid/vapor stream that enters the suction or secondary inlet 203 of the ejector 220. The ejector 220 entrains the refrigerant flow exiting the expansion valve 114 from the receiver 110, which enters the ejector 220 at the primary inlet 201 with refrigerant liquid entering the secondary inlet 203 from the liquid-side outlet 207. The vapor from the liquid separator 124 is fed to the compressor 104 and condenser 106, as generally discussed above.

In this example of CCRS 299, the evaporator 116 is placed between the outlet of the ejector 220 and the liquid separator inlet 125; thus, CCRS 299 avoids the necessity of having liquid refrigerant pass through the liquid separator 124 during the initial charging of the evaporator 116 with the liquid refrigerant, in contrast with other example implementations with different evaporator placement. At the same time liquid trapped in the liquid separator 124 may be wasted after the CCRS 299 shuts down.

When a fixed orifice device is not used, the electrically controlled expansion valve 114 can be used to operate with sensors (not shown). For example, the sensors can monitor vapor quality at the evaporator outlet, pressure in the refrigerant receiver, pressure differential across the expansion valve 114, pressure drop across the evaporator 116, liquid level in the liquid separator 124, power input into electrically actuated heat loads or a combination of the above.

The absorber/desorber 132 (with the optional solenoid control valve 130) in CCRS 299 can be operated as follows. In a first example mode of operation, the low heat load 120 and/or high heat load 118 correspond to compressor pumping capacity, and compressor 104 processes all vapor formed in the evaporator 116. The absorber/desorber 132 neither absorbs nor generates any refrigerant vapor.

In a second example mode of operation, the low heat load 120 and/or the high heat load 118 exceeds the compressor flow pumping capacity, and a portion of vapor formed in the evaporator 116 is induced by the compressor 104. The remaining portion is absorbed by the IL 990 in the absorber/desorber 132 operating as an absorber. When the heat loading on the evaporator 116 increases, the superheat generated at the evaporator outlet increases as well. In response, the expansion valve 114 increases the orifice opening and the flow rate through the evaporator 116 to satisfy the increased heat load and the increased superheat. When the flow rate exceeds the compressor pumping capacity, the evaporating and suction pressures concomitantly increase, destroying the refrigerant vapor—ionic liquid equilibrium. The excessive amount of formed refrigerant vapor at the outlet of the evaporator 116 is absorbed by the IL in the absorber/desorber 132 until the equilibrium is re-established at the increased evaporating pressure. The receiver 110 is sized to sustain the increased refrigerant mass flow rate demand in this case.

In a third example mode of operation, the low heat loading on the evaporator 116 decreases, and the superheat at the evaporator outlet 123 decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor that was desorbed from the absorber/desorber 132 into the receiver 110 until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator. If the heat loading is small, the additional optional solenoid control valve 128 may be open to allow circulation of the evaporator to cool the heat loads.

In this example, the ejector 220 acts as a “pump,” to “pump” a secondary fluid flow, e.g., liquid/vapor from the evaporator 116 using energy of the primary refrigerant flow from the receiver 110. The ejector 220 includes a suction chamber, a mixing chamber for the primary flow of refrigerant and secondary flow of refrigerant to mix, and a diffuser section located at the ejector outlet 205. In example embodiments, the ejector 220 is passively controlled by built-in flow control. Liquid refrigerant from the receiver 110 is the primary flow. In an ejector motive nozzle, potential energy of the primary flow is converted into kinetic energy reducing the potential energy (the established static pressure) of the primary flow. The secondary flow from the outlet 123 of the evaporator 116 (through the liquid separator 124) has a pressure that is higher than the established static pressure in the suction chamber, and thus the secondary flow is entrained through the secondary inlet 203 and a secondary nozzle(s) internal to the ejector 220. The two streams (primary flow and secondary flow) mix together in the mixing chamber. In a diffuser section, the kinetic energy of the mixed streams is converted into potential energy elevating the pressure of the mixed flow liquid/vapor refrigerant that leaves the ejector 220 and is fed to the liquid separator 124 (through the evaporator 116 in some implementations).

The ejector 220 allows for recirculation of liquid refrigerant captured by the liquid separator 124 to increase the efficiency of the various embodiments of FIG. 2. That is, by allowing for some recirculation of refrigerant, minimizing the requirements for the compressor 104 and the condenser 106, this recirculation reduces the required amount of power and size of the compressor 104 and condenser 106 needed for a given amount of cooling of high heat loads 118 over a given period of operation. The ejector 220 can simplify control of the vapor quality at the evaporator outlet 123. The expansion valve 114 is used to maintain a pressure differential across an ejector motive nozzle. The liquid separator 124 can feed the compressor 104 with saturated vapor when the system does not have a recuperative heat exchanger 122. If a recuperation heat exchanger 122 is used, the compressor 104 is fed by superheated vapor—this applies to all ejector embodiments.

In another example implementation of CCRS 299, evaporator 116 is positioned such that the outlet 123 is fluidly coupled to the low pressure inlet 203 of the ejector 220, and the inlet 121 is fluidly coupled to the outlet of optional expansion valve 202 to provide an ejector-assisted closed-circuit refrigeration system. Thus, the ejector 220 has a primary inlet 201 (or high-pressure inlet) that is coupled to the receiver 110 (either directly or through the optional solenoid control valve 112 and/or expansion valve 114). Ejector outlet 205 is coupled to the inlet 125 of the liquid separator 124. The ejector 220 also has the secondary inlet 203 (or low-pressure inlet). The liquid separator 124 in addition to the liquid separator inlet 125 has the vapor-side outlet 127 and the liquid-side outlet 207. The vapor-side outlet 127 of the liquid separator 124 is coupled to an inlet of the optional solenoid control valve 128 (if used) or to the portion of CCRS 299 with the compressor 104 and the absorber/desorber 132, via optional solenoid control valve 130. The outlet of the optional solenoid control valve 130 is coupled to the bidirectional port 129 of the absorber/desorber 132. The ejector 220, in this example, operates as a booster-compressor and reduces the compressor power since the evaporating temperature and pressure are below the compressor suction pressure.

In the closed-circuit refrigeration configuration of CCRS 299, circulating refrigerant enters the compressor 104 as a saturated or superheated vapor and is compressed to a higher pressure at a higher temperature (a superheated vapor). This superheated vapor is at a temperature and pressure at which it can be condensed in the condenser 106 by either cooling water 126 or cooling air 126 flowing across a coil or tubes in the condenser 106. At the condenser 106, the circulating refrigerant loses heat and thus removes heat from the TMS 200, which removed heat is carried away by either the water or air (whichever may be the case) flowing over coil or tubes in the condenser 106, providing a condensed liquid refrigerant.

The condensed liquid refrigerant is returned to the receiver 110. Refrigerant from receiver 110 enters into the primary inlet 201 of the ejector 220 and flows through the ejector loop, meaning that refrigerant flows from the ejector 220 into liquid separator 124 and flow from the liquid separator 124 is expanded by the optional expansion valve 202 into the evaporator 116, which cools heat loads 120 and/or 118. The refrigerant is returned to the ejector 220 and to the liquid separator 124, while a vapor fraction of the refrigerant is fed to the compressor 104 and to the condenser 106, as discussed above.

The liquid separator 124 is used to insure only vapor exists at the inlet to the compressor 104. During operation, the absorber/desorber 132 operates according to the operational modes discussed above. That is, the absorber/desorber 132 in the first mode when the low heat load 120 and/or 118 correspond to compressor pumping capacity, compressor 104 processes all vapor formed in the evaporator 116. The absorber/desorber 132 neither absorbs nor generates any refrigerant vapor. In the second mode, when the low heat load 120 and/or the high heat load 118 exceeds the compressor flow pumping capacity, a portion of vapor formed in the evaporator 116 is induced by the compressor 104. The remaining portion is absorbed by the IL 990 in the absorber/desorber 132 operating as an absorber, and in the third mode when the low heat loads 120 and/or 118 on the evaporator 116 decreases, the superheat at the evaporator outlet decreases as well. In response, the expansion valve 114 decreases the orifice opening and the flow rate through the evaporator 116 to satisfy the decreased heat load and the decreased superheat.

In some example aspects of CCRS 299, the ejector loop can include two or more evaporators 116, including a first evaporator having an inlet coupled to the ejector outlet 205 and a second evaporator having an outlet coupled to the low pressure inlet 203 of the ejector 220. Thus, in some examples, the CCRS 299 can have two evaporators 116: one coupled between the ejector outlet 205 and the inlet 125 to the liquid separator 124, and the other coupled between optional expansion valve 202 outlet and the secondary inlet 203 to the ejector 220, respectively. Such example implementations of CCRS 299 would otherwise similar to the embodiments of FIG. 2, including the absorber/desorber 132. Heat loads 120, 118 can be in thermal conductive and/or convective contact with or in proximity to both of the dual evaporators 116 such that both evaporators 116 extract heat from the heat loads 120 and/or 118.

In example implementations of the CCRS 299 with dual evaporators 116, a sensor (such as sensor 134) can be positioned at an outlet of one of the evaporators 116 between the evaporator and the secondary inlet 203 of the ejector 220. The dual evaporators 116 can operate in the two phase (liquid/gas) and superheated region with controlled superheat. The optional expansion valve 202 can include a control port that is fed from the sensor. The expansion valve 202 and sensor provide a mechanism to measure and control superheat.

The cooling capacities of the CCRS 299 with a single evaporator 116 (disposed between the ejector outlet 205 and liquid separator inlet 125, or between the liquid separator outlet 207 and the motive inlet 203) can be sensitive to recirculation rates. A dual evaporator configuration of CCRS 299 (as described) may not be not sensitive to recirculation rate, which may be beneficial when the heat loads may significantly reduce recirculation rate. An operating advantage of a dual evaporator configuration is that by placing evaporators 116 at both the ejector outlet 205 and the secondary inlet 203 of the ejector 220, it is possible to run the evaporators 116 combining the features of the configurations mentioned above.

As another example implementation of CCRS 299, the CCRS 299 can include a single evaporator 116 having first and second fluid paths. A first fluid path can be attached upstream from the liquid separator inlet 125, and a second fluid path can be attached downstream of the liquid-side outlet 207. The evaporator 116, in such an example, has a first inlet 121 that is coupled to the ejector outlet 205 and a first outlet 123 that is coupled to the liquid separator inlet 125. The evaporator 116 has a second inlet 121 that is coupled to the outlet of the second optional expansion valve 202 and has a second outlet 123 that is coupled to the secondary inlet 203 of the ejector 220. The vapor-side outlet 127 of the liquid separator 124 is coupled via the optional solenoid control valves 128 and 130 to the absorber/desorber 132. The heat loads 120 and 118 are coupled to the single evaporator 116 to extract heat from the heat loads 120 and 118.

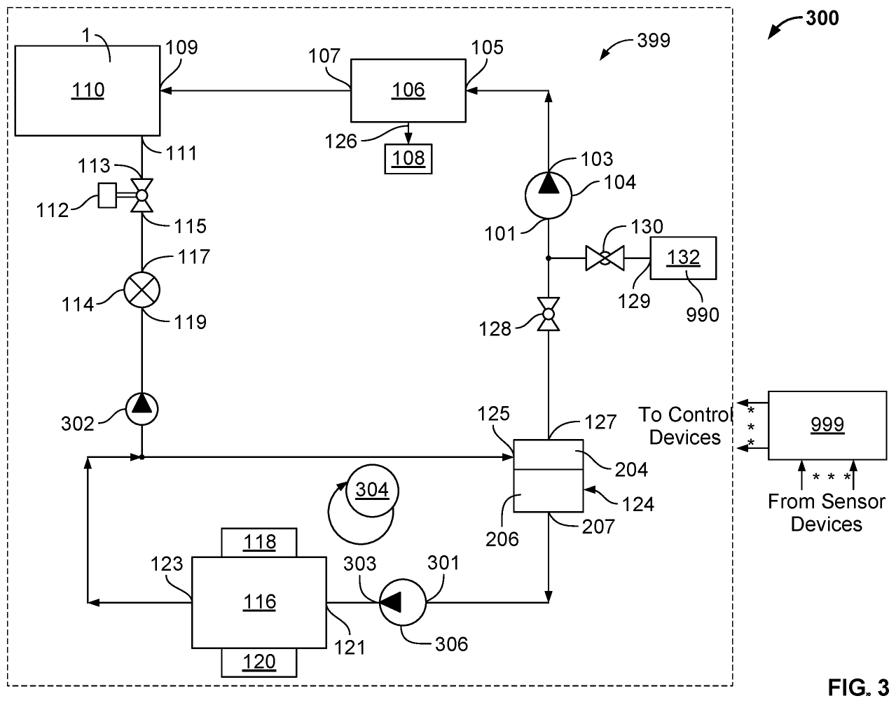

FIG. 3 shows another schematic diagram of an example implementation of a thermal management system (TMS) 300 that includes a CCRS 399 with the IL 990 in absorber/desorber 132 along with a pump-assisted closed-circuit refrigeration circuit. Items illustrated and referenced, but not mentioned in the discussion below, are discussed and referenced in FIG. 1 or FIG. 2. Referring now to FIG. 3, CCRS 399 includes the evaporator 116, with heat loads 120, 118. The inlet 121 of the evaporator 116 is coupled to an outlet 303 of a pump 306. CCRS 399 includes the receiver 110 that is configured to store liquid refrigerant, i.e., subcooled liquid refrigerant, optional solenoid control valve 112, the expansion valve 114, and a check valve 302. The check valve 302 is used to prevent back flow when the pump 306 is ON and compressor 104 is OFF.

CCRS 399 includes liquid separator 124 (e.g., rather than a suction accumulator). The liquid separator 124 can have alternative configurations (implemented as a flash drum, for example), which has the inlet 125, vapor-side outlet 127, and liquid-side outlet 207. In some examples, the pump 306 is located distal from the liquid-side outlet 207. This configuration potentially presents the possibility of cavitation. In another example, the pump 306 is located distal from the liquid-side outlet 207, but the height at which the inlet 125 is located higher on the separator 124. This would result in an increase in liquid pressure at the liquid-side outlet 207 of the liquid separator 124 and concomitant therewith an increase in liquid pressure at the inlet 301 of the pump 306. Increasing the pressure at the inlet to the pump 306 should minimize possibility of cavitation. Another strategy is to position the pump 306 proximate to or indeed inside of the liquid-side outlet 207. In addition, a height at which the inlet 125 is located can be adjusted to be higher on the separator 124. This would result in an increase in liquid pressure at the inlet 301 of the pump 306 further minimizing the possibility of cavitation. Another alternative strategy that can be used for any implementation involves the use of a sensor (e.g., positioned inside the liquid separator 124 at or near the vapor outlet 127 or at the height of the inlet 125 that produces a signal that is a measure of the height of a column of liquid in the liquid separator 124. The signal is sent to the controller 999 that will be used to start the pump 306 once a sufficient height of liquid is contained by the liquid separator 124.

Another alternative strategy that can be used for any of the configurations depicted involves the use of a heat exchanger. The heat exchanger is an evaporator, which brings in thermal contact two refrigerant streams. In the above systems, a first of the streams is the liquid stream leaving the liquid separator 124. A second stream is the liquid refrigerant expanded to a pressure lower than the evaporator pressure in the evaporator 116 and evaporating the related evaporating temperature lower than the liquid temperature at the liquid separator exit. Thus, the liquid from the liquid separator 124 exit is subcooled rejecting thermal energy to the second side of the heat exchanger. The second side absorbs the rejected thermal energy due to evaporating and superheating of the second refrigerant stream.

CCRS 399 also includes the absorber/desorber 132, the compressor 104, and the condenser 106 having the outlet 107 coupled to the inlet 109 of receiver 110, as discussed above. The CCRS 399 includes a loop circuit 304 having a junction at or near the check valve 302, the evaporator 116, the liquid separator 124, and the pump 306.

The junction has a first port coupled to the receiver 110 (e.g., through optional solenoid control valve 112) and expansion valve 114, a second port coupled to the outlet 123 of the evaporator 116, and a third port coupled to the liquid separator inlet 125. The liquid separator 124 has the inlet 125, the vapor-side outlet 127, and the liquid-side outlet 207, as well as vapor section 204 and liquid section 206. The vapor-side outlet 127 is coupled to optional solenoid control valve 128, if used, which is coupled to the compressor 104 and the absorber/desorber 132 so that refrigerant vapor can be fed to the compressor 104 and refrigerant vapor can be fed to the optional solenoid control valve 130 and to the absorber/desorber 132. The liquid-side outlet 207 of the liquid separator 124 is coupled to an inlet 301 of the pump 306.

In CCRS 399, refrigerant liquid from the liquid-side outlet 207 of the liquid separator 124 is fed to pump inlet 301 and is pumped from the pump 306 into the inlet 121 of the evaporator 116. Refrigerant exiting from the evaporator outlet 1230 is fed along with the primary refrigerant flow from the expansion valve 114 back to the liquid separator 124. These liquid refrigerant streams from the receiver 110 and the pump 306 are mixed downstream from the expansion valve 114. Heat loads 120, 118 are in thermal conductive and/or convective contact with or in proximity to the evaporator 116. The evaporator 116 is configured to extract heat from the heat loads 120, 118 and to control the vapor quality or superheat at the outlet 123 of the evaporator 116.

CCRS 399 can operate as follows. The liquid refrigerant from the receiver 110 is fed to the expansion valve 114 and expands at a constant enthalpy in the expansion valve 114 turning into a two-phase (gas/liquid) mixture. This two-phase liquid/vapor refrigerant is fed to the liquid separator inlet 125, where the liquid separator 124 separates the refrigerant with only or substantially only refrigerant liquid exiting the liquid separator 124 at the liquid-side outlet 207 and only or substantially only refrigerant vapor exiting the vapor-side outlet 127. The liquid stream exiting at liquid-side outlet 207 enters and is pumped by the pump 306 into the evaporator 116 that provides the cooling duty and discharges the refrigerant in a two-phase state at superheat or at a relatively high exit vapor quality (fraction of vapor to liquid). The discharged refrigerant is fed to the junction. Vapor from the vapor-side outlet 127 of the liquid separator 124 is fed to the compressor 104 on to the condenser 106 back into the receiver 110 for closed-circuit operation.

The absorber/desorber 132 (with the optional solenoid control valve 130), operates as follows with respect to the CCRS 399. In a first example mode of operation, the heat load 120 and/or 118 correspond to compressor pumping capacity, and compressor 104 processes all vapor formed in the evaporator 116. The absorber/desorber 132 neither absorbs nor generates any refrigerant vapor. In a second example mode of operation, the heat load 120 and/or high heat load 118 exceeds the compressor flow pumping capacity, and a portion of vapor formed in the evaporator 116 is induced by the compressor 104. The remaining portion is absorbed by the IL 990 in the absorber/desorber 132 operating as an absorber. When the heat load 120 and/or high heat load 118 are on, the evaporator 116 increases the superheat generated at the evaporator outlet. In response, the expansion valve 114 increases the orifice opening and the flow rate through the evaporator 116 to satisfy the increased heat load and the increased superheat. When the flow rate exceeds the compressor pumping capacity, the evaporating and suction pressures concomitantly increase, destroying the refrigerant vapor—ionic liquid equilibrium. The excessive amount of formed refrigerant vapor at the outlet of the evaporator 116 is absorbed by the IL 990 in the absorber/desorber 132 until the equilibrium is re-established at the increased evaporating pressure. The receiver 110 is sized to sustain the increased refrigerant mass flow rate demand in this case.

In a third example mode of operation of CCRS 399, the heating load on the evaporator 116 decreases, and the superheat at the evaporator outlet decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor to pump refrigerant vapor that was desorbed from the absorber/desorber into the receiver 110 until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator. If the heat loading is small, the additional optional solenoid control valve 128 may be open to allow circulation of the evaporator to cool the heat loads.

Various types of pumps can be used for pump 306. Exemplary types include gear, centrifugal, rotary-vane, types. When choosing a pump, the pump 306 should be capable to withstand the expected fluid flows, including criteria such as temperature ranges for the fluids, and materials of the pump 306 should be compatible with the properties of the fluid. A subcooled refrigerant can be provided at the pump outlet 303 to avoid cavitation. To do that a certain liquid level in the liquid separator 124 may provide hydrostatic pressure corresponding to that sub-cooling.

In a modified aspect of CCRS 399, the CCRS 399 can include a dual evaporator scheme as described with reference to FIG. 2. For example, a first evaporator 116 can be coupled between the outlet of the junction (near the check valve 302) and the liquid separator inlet 125, and a second evaporator 116 can have an inlet that is coupled to the outlet 303 of the pump 306 and an outlet coupled to a second inlet of the junction (near check valve 302). Heat loads 118, 120 can be coupled to both evaporators 116 in a dual evaporator scheme of CCRS 399. An operating advantage of the dual evaporator scheme is that it is possible to combine loads which require operation in the two-phase region and which allows operation with superheat.

As another example implementation of CCRS 399, the CCRS 399 can include a single evaporator 116 having first and second fluid paths. A first fluid path can be attached upstream from the liquid separator inlet 125, and a second fluid path can be attached downstream of the pump outlet 303. The evaporator 116, in such an example, has a first inlet 121 that is coupled to the outlet of the junction near check valve 302, and a first outlet 123 that is coupled to the liquid separator inlet 125. The evaporator 116 has a second inlet 121 that is coupled to the pump outlet 303 and has a second outlet 123 that is coupled to one of the inputs of the junction near check valve 302. The heat loads 120 and 118 are coupled to the single evaporator 116 to extract heat from the heat loads 120 and 118.

In some aspects of CCRS 399, the junction near check valve 302 can be positioned such that the optional solenoid valve 112 is upstream of one inlet, another inlet is coupled to the outlet 123, and the outlet of the junction feeds the expansion valve 114 and then the check valve 302 (in series). In some aspects of CCRS 399, the junction near check valve 302 can be positioned such that the optional solenoid valve 112, the expansion valve 114, and the check valve 302 are upstream (in series) of one inlet, another inlet is coupled to the outlet 123, and the outlet of the junction feeds the separator inlet 125.

FIG. 4 shows another schematic diagram of an example implementation of a thermal management system (TMS) 400 that includes a CCRS 499 with the IL 990 in absorber/desorber 132 along with a modulation capacity control circuit 420 to provide modulated, closed-circuit refrigeration for low heat loads 120 over long time intervals and/or refrigeration for high heat loads 118 over short time intervals (relative to the amount of heat and the interval of refrigeration of the low heat load). CCRS 499 includes the receiver 110 that stores refrigerant, the expansion valve 114, the evaporator 116, the suction accumulator 124 having the inlet 125 and the vapor-side outlet 127, the compressor 104, and the condenser 106 (or a gas cooler of a trans-critical refrigeration system). CCRS 499 also includes optional solenoid control valve 130. The outlet of the optional solenoid control valve 130 is coupled to the bidirectional port 129 of the absorber/desorber 132. Further, as shown, the CCRS 499 includes the optional recuperative heat exchanger 122.

CCRS 499 can also include an optional solenoid control valve (not shown) coupled between the receiver outlet 111 and the expansion valve inlet 117 (through heat exchanger 122 if used) and can be used when the expansion valve 114 is not configured to completely stop refrigerant flow when the TMS 400 is in an off state. Expansion valve 114 is configured to cause adiabatic flash evaporation of a part of liquid refrigerant received from the receiver 110. In some aspects, TMS 400 (like all of the examiner TMS in this disclosure) can include an oil return path.

CCRS 499 handles cooling of the high heat loads 118, and low heat loads 120 that operate continuously. If precise control of the heat load temperatures is required, one technique to provide precise control of the heat load temperatures includes use of a variable speed compressor 104 and/or a variable speed condenser cooling fluid fan/pump 108. However, the variable speed compressor 104 has a limited speed range. The variable speed condenser cooling fluid fan/pump 108 also has limits as well. If these controls are the only mechanisms used for capacity/temperature control, the control offered may not be sufficient.

Therefore, in CCRS 499, a modulating capacity control circuit 420 for controlling cooling of temperature varying heat loads is shown. The modulating capacity control circuit 420 adds modulation capacity control to the CCRS 499. The TMS 400 with the modulating capacity control circuit 420 can generate any cooling capacity in the capacity range of zero to full capacity of the CCRS 499 to satisfy various heat loads in a heat load range from 0 to the full load capacity. The modulating capacity control circuit 420 includes one or more of a head pressure valve 402 connected between condenser 106 and receiver 110 in bypass 401, a bypass valve 406 (that bypasses hot gas in conduit 403), a quench valve 404 in conduit 405, and a mixer 408 with mixer inlet 407 and mixer outlet 409. The quench valve 404, the hot gas bypass valve 406, and the head pressure valve 402 are available as mechanical devices with built in control capability, and as electronic devices.

The bypass valve 406 is coupled between the compressor outlet 103, via conduit 403 and junctions. The bypass valve 406 is controlled or responsive to a signal that comes either from a sensor 412 (or indirectly from the sensor 412 via the controller 999). The quench valve 404 is coupled, via conduit 405, between the receiver outlet 111 and mixer inlet 407 (through a junction). The quench valve 404 is controlled or responsive to a signal that comes either from a sensor 410 (or indirectly from the sensor 410 via the controller 999). The mixer 408 is coupled between junctions on conduit 405. The mixer 408 is coupled to the quench valve 404 and the compressor inlet 101.

The modulating capacity control circuit 420 includes the hot gas bypass valve 406, the quench valve 404, and the head pressure valve 402, as shown. However, not all of these components are necessarily included in a given TMS 400. In some implementations, there may only be the bypass valve 406 interacting with the quench valve 404 and mixer 408. In other implementations there only may be the head pressure valve 402. However, even when the TMS 400 has the bypass valve 406, the quench valve 404, and the head pressure valve 402, each of these components need not be ON at the same time. That is, these components can used together or independently of each other.

When the heat load 120 and/or 118 are applied, the TMS 400 is configured to have the CCRS 499 provide refrigeration to the low heat load 120. In the closed-circuit refrigeration configuration, circulating refrigerant enters the compressor 104 as a saturated or superheated vapor and is compressed to a higher pressure at a higher temperature (a superheated vapor). This superheated vapor is at a temperature and pressure at which it can be condensed in the condenser 106 by either cooling water or cooling air (e.g., provided by a variable flow pump or fan 108) flowing across a coil or tubes in the condenser 106. Compressed circulating refrigerant fluid exits from the compressor 104.

When the heat load matches the full capacity of the refrigeration system, no hot gas bypass control may be engaged. The hot gas bypass operation may be engaged only when the load on the evaporator 116 is reduced, and the TMS 400 may reduce the evaporator capacity to match the heat load (e.g., heat loads 120 and/or 118). One of the options to match the load is to utilize a variable speed (i.e., frequency) drive on the compressor 104. This option is not always available and even it is available there may be restrictions for the speed reduction.

In an example implementation of the CCRS 499, a first portion of the compressed circulating refrigerant is fed to the condenser 106 and a second portion of the compressed circulating refrigerant is fed to the modulating capacity control circuit 420. At the condenser 106, the first portion of the circulating refrigerant loses heat and thus removes heat from the TMS 400, which removed heat is carried away by either the water or air 126 (whichever may be the case) flowing over the coil or tubes, providing a condensed liquid refrigerant. The first portion of the circulating refrigerant is routed into the receiver 110 through receiver inlet 109, exits the receiver 110 through receiver outlet 111. Then liquid refrigerant splits in two parts. One part enters the quench valve 404 and the other part enters expansion valve 114. The first liquid portion is enthalpically expanded in the quench valve 404 and mixes with the hot gas in the mixer 408 and discharges as a superheated vapor at the mixer outlet 409. The quench valve 405 can control a superheat at the outlet 409 and the hot gas bypass valve 406 controls the compressor suction pressure. Then the superheated vapor mixes with the compressor suction stream.

The hot gas bypass valve 406 can reduce an amount of refrigerant going to the evaporator 116 since significant portions of refrigerant bypasses the evaporator 116 through the valves 406 and 404, and the second liquid portion which is smaller than a flow rate pumped by the compressor 104 enters the expansion valve 114 (through an optional solenoid control valve 112, if used). The refrigerant is enthalpically expanded in the expansion valve 114 and the high pressure sub-cooled liquid refrigerant turns into liquid-vapor mixture at a low pressure and temperature. The temperature of the liquid and vapor refrigerant mixture (evaporating temperature) is lower than the temperature of the low heat load 120. The mixture is routed through a coil or tubes in the evaporator 116. The heat from the heat load 120, in contact with or proximate to the evaporator 116, evaporates the liquid portion of the two-phase refrigerant mixture, and may superheat the refrigerant stream. The saturated or superheated vapor exiting the evaporator 116 passes through the suction accumulator 124 and enters the compressor 104 via junctions. The evaporator 116 is where the circulating refrigerant absorbs and removes heat from the applied low heat load 120 which heat is subsequently rejected in the condenser 106 and transferred to an ambient by water or air used in the condenser 106. To complete the refrigeration cycle, the refrigerant vapor from the evaporator 116 passes the suction accumulator 124 and is routed back into the compressor 104. The suction accumulator 124 captures non-evaporated liquid accidently slugged through the mixer 408 and then returns it into the suction stream.

Low ambient conditions may cause significant reduction of the condensing and discharge pressures. In order to avoid the pressure reduction below the operating envelope of the compressor 104 and/or the expansion valve 114 and/or quench valve 404, the head pressure control can be engaged. In this case, head pressure control valve 402 is engaged. The valve 402 incorporates two functions or two valves. One valve controls pressure in the condenser 106 and the other controls pressure differential across the condenser 106. Optionally, two valves can be used. When the condensing/discharge pressure hits the limit, the valve 402 closes a liquid path orifice causing accumulation of liquid refrigerant upstream, that is in the condenser 106. At the same time, the valve 402 opens an orifice for vapor in conduit 401 to maintain a relatively high pressure in the receiver 110 to satisfy a set pressure differential across the valve 402.

Thus, first compressed circulating refrigerant sub-portion that is fed into the receiver 110 and the hot gas bypassed, i.e., the second compressed circulating refrigerant sub-portion, both bypass the evaporator 116 to appropriately accommodate the reduced heat load(s) 120, 118. The mixer 408 operates as a mixing heat exchanger providing direct contact of the expanded vapor stream and two-phase mixture formed after the expansion of the liquid stream at the low pressure.

The hot gas bypass valve 406, as controlled by sensor 412, controls a set low evaporating/suction pressure. The hot gas bypass valve 406 is actuated when the evaporating pressure is reduced below the set evaporating/suction pressure limit. The quench valve 404 is an expansion valve that controls refrigerant superheat at the mixer 408 exit. The quench valve 404 opens a refrigerant flow when the superheat increases and thus increases the refrigerant flow rate to recover the increase in superheat. The quench valve 404 closes the refrigerant flow opening when the superheat is reduced, and thus reduces the refrigerant flow rate to recover lessened superheat. The mixer 408 mixes the refrigerant vapor (first sub-portion) and the two-phase mixture (expanded refrigerant liquid/vapor). The refrigerant liquid portion evaporates, leaving the mixer 408 with the superheat controlled by the quench valve 404.

Condensing temperature depends on ambient temperature. When ambient temperature is low, the condensing pressure temperature is low as well. At a certain low condensing pressure, a pressure difference between the condensing and evaporating pressures and compressor discharge and suction pressures becomes very low and unacceptable for proper operation of the compressor 104, the expansion valve 114, and the quench valve 404. The head pressure valve 402 therefore is provided to control the condensing pressure to be above the set low limit.

An approach for maintaining normal head pressure in the refrigeration system during periods of low ambient temperature is to restrict liquid refrigerant flow from the condenser 106 to the receiver 110. At the same time, the modulating capacity control circuit 420 diverts hot gas to the inlet of the receiver 110. This diversion backs liquid refrigerant up into the condenser 106 reducing the condenser capacity which, in turn, increases condensing pressure. However, at the same time, the hot gas raises liquid pressure in the receiver, allowing the system to operate normally.

The head pressure valve 402 restricts liquid flow exiting the condenser 106 when the ambient air that is cooling the condenser 106 is very cold. As a result, refrigerant liquid accumulates in the condenser 106 reducing the volume and heat transfer area for the incoming high pressure refrigerant vapor that is discharged from the compressor 104. With reduced condenser volume, a condensation rate is reduced and pressure in the condenser 106 and in the compressor discharge line increases, opening the other port of the head pressure valve 402, and high pressure refrigerant vapor flows into the receiver 110 elevating the refrigerant pressure in the receiver 110. Generally, low ambient temperature provides lower condensing pressure, lower pressure in the receiver 110, lower pressure at the inlet 117, and a lower pressure differential across the expansion valve 114. The head pressure valve 402 elevates the pressure differential across the expansion valve 114 to a level at which the expansion valve 114 becomes operable. The head pressure valve 402 may or may not be used in conjunction with the variable flow fan 108 pulling air through the condenser 106. Alternatively, in some implementations, the speed at which the variable flow fan 108 pulls air through the condenser 106 can be used to control head pressure, without the need for head pressure valve 402.

Operation of the absorber/desorber 132 in the CCRS 499 occurs according to one of the following operational modes. In a first example operational mode, heat from the heat loads 120 and/or 118 correspond to compressor pumping capacity, and compressor 104 processes all vapor formed in the evaporator 116. The absorber/desorber 132 neither absorbs nor generates any refrigerant vapor. In a second example operation mode, the heat loads 120 and/or 118 exceed the compressor flow pumping capacity, with the modulation control at a maximum amount of refrigerant flow, and a portion of vapor formed in the evaporator 116 is induced by the compressor 104. The remaining portion is absorbed by the IL 990 in the absorber/desorber 132 operating as an absorber.

When the heat from heat loads 120 and/or 118 on the evaporator 116 increases, the superheat generated at the evaporator outlet increases as well. In response, the expansion valve 114 increases the orifice opening and the flow rate through the evaporator 116 to satisfy the increased heat load and the increased superheat. When the flow rate exceeds the compressor pumping capacity, e.g., with the modulation control at its maximum amount of refrigerant flow, the evaporating and suction pressures concomitantly increase, destroying the refrigerant vapor—ionic liquid equilibrium. The excessive amount of formed refrigerant vapor at the outlet of the evaporator 116 is absorbed by the IL 990 in the absorber/desorber 132 until the equilibrium is re-established at the increased evaporating pressure. The receiver 110 is sized to sustain the increased refrigerant mass flow rate demand in this case with the modulation control set at its maximum amount of refrigerant flow.

In a third example operation mode, the heat from heat loads 120 and/or 118 on the evaporator 116 decreases, and the superheat at the evaporator outlet 123 decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor that was desorbed from the absorber/desorber 132 into the receiver 110 until the refrigerant vapor—ionic liquid equilibrium is recovered at a reduced evaporating pressure, which occurs at a minimum amount of the modulation control for refrigerant flow. If the heat loading is negligible or does not exist, the additional optional solenoid control valve 16c may stay closed to avoid pressure reduction in the evaporator. If the heat loading is small, the additional optional solenoid control valve 16c may be open to allow circulation of the evaporator to cool the heat loads.

The CCRS 499 generally also includes the controller 999 that produces control signals (based on sensed thermodynamic properties) to control operation of the various devices, e.g., expansion valve 114, quench valve 404, bypass valve 406, etc., as needed, as well as the compressor 104. Controller 999 may receive signals, process received signals and send signals (as appropriate) from/to these devices, and a motor of the compressor 104 changing its speed, shutting compressor 104 off or starting it, etc.

As shown in this example of CCRS 499, the CCRS 499 includes both the modulating capacity control circuit 420 and the recuperative heat exchanger 122. The recuperative heat exchanger 122 allows for recuperation of the energy of the cold refrigerant and reduces the mass flow rate demand during cooling of the high heat load 118, while saving energy during cooling of the low heat load 120. It also allows for lower vapor quality at the evaporator 116 exit because the recuperative heat exchanger 122 evaporates any remaining liquid prior to being fed to the inlet of the compressor 104. In some implementations, the presence of a recuperative heat exchanger 122 can eliminate the need for the suction accumulator 124.

The recuperative heat exchanger 122 is coupled in an input path between the receiver 110 and the expansion valve 114 and in an output path from vapor-side outlet 127 of the suction accumulator 124 toward the compressor 104. The recuperative heat exchanger 122 transfers heat energy from the refrigerant fluid emerging from suction accumulator 124 to refrigerant fluid upstream from expansion valve 114. Inclusion of the recuperative heat exchanger 122 reduces mass flow rate demand and allows operation of evaporator 116 within threshold of vapor quality.

The closed circuit refrigeration operation is similar with the recuperative heat exchanger 122 as without. With vapor quality less than 1, when the two-phase mixture of refrigerant fluid is directed into evaporator 116, the liquid phase absorbs heat from heat loads 120 and/or 118, driving a phase transition of the liquid refrigerant fluid into the vapor phase. Because this phase transition occurs at (nominally) constant temperature, the temperature of the refrigerant fluid mixture within evaporator 116 remains unchanged, provided at least some liquid refrigerant fluid remains in evaporator 116 to absorb heat. Further, the constant temperature of the refrigerant fluid mixture within evaporator 116 can be controlled by adjusting the pressure pₑ of the refrigerant fluid, since adjustment of pₑ changes the boiling temperature of the refrigerant fluid. Thus, by regulating the refrigerant fluid pressure pₑ upstream from evaporator 116, the temperature of the refrigerant fluid within evaporator 116 (and, nominally, the temperature of high heat load 118) can be controlled to match a specific temperature set-point value for high heat load 118, ensuring that heat loads 120-118 are maintained at, or very near, a target temperature. Additionally, further control is provided by the modulating capacity control circuit 420 that adjusts cooling capacity based on varying cooling requirements for the heat loads 120 and/or 118.

Within evaporator 116, a portion of the liquid refrigerant in the two-phase refrigerant fluid mixture is converted to refrigerant vapor by undergoing a phase change. As a result, the refrigerant fluid mixture that emerges from evaporator 116 has a higher vapor quality (i.e., the fraction of the vapor phase that exists in refrigerant fluid mixture) than the refrigerant fluid mixture that enters evaporator 116. Any excess vapor from the recuperative heat exchanger outlet that cannot be pumped by the reduced sized compressor 104 is absorbed by the absorber/desorber 132.

The modulating capacity control circuit 420 of CCRS 499 can be used with an ejector assisted circuit (e.g., as shown in FIG. 2). For example, in an ejector assisted circuit, an ejector (e.g., ejector 220) can be used to assist in reducing a power requirement of the TMS 400. Just as in FIG. 2, an ejector can be positioned such that the suction inlet is coupled to the outlet 119 of the expansion valve 114 and the ejector outlet is coupled to the inlet 121 of the evaporator 116. A liquid outlet of a liquid separator (as opposed to a suction accumulator) can be coupled (through an expansion valve or not) to a motive inlet of the ejector. Alternatively, the ejector outlet can be coupled to the separator inlet of the liquid separator, while the liquid outlet of the liquid separator can be coupled (through an expansion valve or not) to an inlet 121 of the evaporator 116. The outlet 123 of the evaporator 116 can be coupled to the motive inlet of the ejector. In another alternative implementation, a dual evaporator scheme (as previously described) can be used with the ejector assisted circuit and the modulating capacity control circuit 420. In another alternative implementation, a single evaporator scheme with dual flow paths (two inlets 121 and two outlets 123 as previously described) can be used with the ejector assisted circuit and the modulating capacity control circuit 420.

Such ejector assisted circuit with the modulating capacity control circuit 420 and the absorber/desorber 132 can provide cooling for low heat loads 120 over long time intervals and/or cooling for high heat loads 118 over short time intervals, as generally discussed above with closed-circuit refrigeration operation, as well as with the example first, second, and third modes of operation.

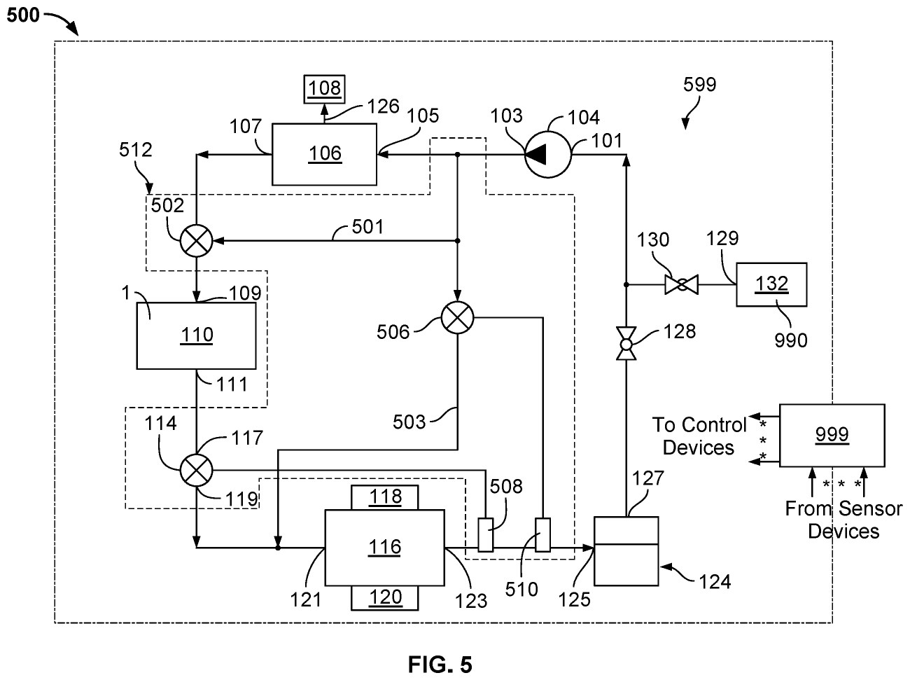

FIG. 5 shows another schematic diagram of an example implementation of a thermal management system (TMS) 500 that includes a CCRS 599 with the IL 990 in absorber/desorber 132 along with another alternative modulation capacity control circuit 512. As shown in FIG. 5, the modulation capacity control circuit 512 is shown in dashed line enclosure and comprises those components within the enclosure: head pressure valve 502, expansion valve 114, hot gas bypass valve 506, and sensors 508 and 510. Alternatively, modulation capacity control circuit 512 can comprise the compressor 104, the condenser 106, the head pressure valve 502, the receiver 110, the expansion valve 114, the hot gas bypass valve 506, an optional quench valve positioned in conduit 503 (not shown), optional solenoid valve 128, optional solenoid valve 130, and the absorber/desorber 132. Alternatively, in some examples, the modulation capacity control circuit 420 can be used with CCRS 599, and the modulation capacity control circuit 512 can be used with CCRS 499.

TMS 500 includes the alternative modulating capacity control circuit 512 to provide closed-circuit refrigeration for low heat loads 120 over long time intervals and refrigeration for high heat loads 118 over short time intervals (relative to the amount of heat and the interval of refrigeration of low heat load). Not shown in FIG. 5, but which would be typically included, is an oil return path for compressor 104. Other components of TMS 500 have already been described with reference to one or more other figures herein.

The modulating capacity control circuit 512 adds modulation capacity control and can generate any cooling capacity in the capacity range of zero to full capacity of the CCRS 599 to satisfy various heat loads in a heat load range from 0 to the full load capacity of the CCRS 599. The absorber/desorber 132 is used to handle an excessive amount of refrigerant vapor formed at the outlet of the evaporator 116. This excessive amount is absorbed by the IL 990 in the absorber/desorber 132. The modulating capacity control circuit 512 includes the head pressure valve 502 and the bypass valve 506. The condenser fan or pump 108 can be a variable speed fan or pump 108 as well. The head pressure valve 502 may or may not be used in conjunction with the variable flow pump or fan 108 pulling liquid or air through the condenser 106. Alternatively, in some implementations the speed at which the variable flow pump or fan 108 pulls condenser liquid through the condenser 106 and can be used to control head pressure, without the need for head pressure valve 502.

The modulating capacity control circuit 512 can eliminate the quench valve and the mixer of the CCRS 499. The bypass valve 506 is coupled between an outlet 103 of the compressor 104 and the inlet 121 to the evaporator 116, via conduit 503 and a junction. The bypass valve 506 is controlled or responsive to a signal from the sensor 510 (or indirectly from the sensor 510 via the controller 999). The evaporator 116 (and junction upstream of the inlet 121) effectively provide the function of the mixer cooling the hot gas bypass stream. The expansion valve 114 is controlled via the sensor 508 and provides the function of the quench valve. The expansion valve 114 is controlled or responsive to a signal that comes either from the sensor 508 (or indirectly from the sensor 508 via the controller 999).

Closed-circuit refrigeration operation is discussed below including the function of the modulating capacity control circuit 512. In the configuration of FIG. 5, a first portion of the compressed circulating refrigerant is fed to the condenser 106 and a second portion of the compressed circulating refrigerant is fed to the modulating capacity control circuit 512. At the condenser 106, the first portion of the circulating refrigerant loses heat and thus removes heat from the system and the first portion of the circulating refrigerant is routed into the receiver 110, exits the receiver 110, and enters the expansion valve 114 (through an optional solenoid control 112 valve, if used).

The second portion of the compressed circulating refrigerant is split into a first sub-portion and a second sub-portion upstream of the bypass valve 506. The hot gas bypass valve 506 receives the second compressed circulating refrigerant sub-portion from the junction, bypassing the condenser 106, the receiver 110, and the expansion valve 114, and directs the second compressed circulating refrigerant sub-portion into conduit 503. The hot gas bypass valve 506 controls a set low evaporating/suction pressure. If the evaporating/suction pressure is reduced below a set limit value, the hot gas bypass valve 506 is actuated. The refrigerant is expanded in the hot gas bypass valve 506 and the expanded refrigerant enters the evaporator 116. The expansion valve 114 controls refrigerant superheat at the evaporator outlet 123 (with sensor 508). The heat load acting on the evaporator 116, the enthalpy of the hot gas bypassed, and the enthalpy of the two-phase refrigerant formed after liquid expansion in the expansion valve 114 generates the superheat at the evaporator outlet 123. The expansion valve 114 opens the flow opening, when the superheat increases, and thus increases the refrigerant flow rate to recover the growing superheat. The expansion valve 114 closes the flow opening, when the superheat is reduced, thus reducing the refrigerant flow rate to recover lessened superheat. At the inlet 121 of the evaporator 116 and the junction upstream thereof, the vapor and two-phase mixture mix, the liquid portion evaporates, and leaves the evaporator 116 with the superheat controlled by the expansion valve 114.

In CCRS 599, the absorber/desorber 132 (with the optional solenoid control valve 128), operates as follows. In a first example mode of operation, heat load 120 and/or 118 correspond to compressor pumping capacity, compressor 104 processes all vapor formed in the evaporator 116. The absorber/desorber 132 neither absorbs nor generates any refrigerant vapor. In a second example mode of operation, when the heat loads 120 and/or 118 exceed the compressor flow pumping capacity, a portion of vapor formed in the evaporator 116 is induced by the compressor 104. The remaining portion is absorbed by the IL 990 in the absorber/desorber 132 operating as an absorber. When the heat from heat loads 120 and/or 118 on the evaporator 116 increases, the superheat generated at the evaporator outlet 123 increases as well. In response, the expansion valve 114 increases the orifice opening and the flow rate through the evaporator 116 to satisfy the increased heat load and the increased superheat. When the flow rate exceeds the compressor pumping capacity, the evaporating and suction pressures concomitantly increase, destroying the refrigerant vapor—ionic liquid equilibrium. The excessive amount of formed refrigerant vapor at the outlet of the evaporator 116 is absorbed by the IL 990 in the absorber/desorber 132 until the equilibrium is re-established at the increased evaporating pressure. The receiver 110 is sized to sustain the increased refrigerant mass flow rate demand in this case.

In a third example mode of operation, the heat from heat loads 120 and/or 118 on the evaporator 116 decreases, and the superheat at the evaporator outlet 123 decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor that was desorbed from the absorber/desorber 132 into the receiver 110 until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator. If the heat loading is small, the additional optional solenoid control valve 128 may be opened to allow circulation of the evaporator to cool the heat loads.

The modulating capacity control circuit 512 of CCRS 599 can be used with a pump assisted circuit (e.g., as shown in FIG. 3). For example, in a pump assisted circuit, a pump (e.g., pump 306) can be used to assist in reducing a power requirement of the TMS 500. Just as in FIG. 3, a pump can be positioned such that the pump inlet is coupled to the liquid outlet of a liquid separator (such as liquid separator 124) and the pump outlet is coupled to the inlet 121 of the evaporator 116. The conduit 503 can connect to the pump assisted circuit, as can the outlet 119 of the expansion valve 114 (e.g., upstream of the inlet 121 of the evaporator 116).

In another alternative implementation, a dual evaporator scheme (as previously described) can be used with the pump assisted circuit and the modulating capacity control circuit 512. In such a scheme, a pump can be positioned such that the pump inlet is coupled to the liquid outlet of a liquid separator (such as liquid separator 124) and the pump outlet is coupled to the inlet 121 of a first evaporator 116. The outlet 123 of the first evaporator 116 can be coupled (along with conduit 503 and outlet 119 of the expansion valve 114) to the inlet 121 of a second evaporator 116. The outlet 123 of the second evaporator 116 can be coupled to the separator inlet 125 (with sensors 508 and 510 also positioned between the outlet 123 of the second evaporator 116 and the inlet 125).

In another alternative implementation, a single evaporator scheme with dual flow paths (two inlets 121 and two outlets 123 as previously described) can be used with the ejector assisted circuit and the modulating capacity control circuit 512.

Such pump assisted circuit with the modulating capacity control circuit 512 and the absorber/desorber 132 can provide cooling for low heat loads 120 over long time intervals and/or cooling for high heat loads 118 over short time intervals, as generally discussed above with closed-circuit refrigeration operation, as well as with the example first, second, and third modes of operation.

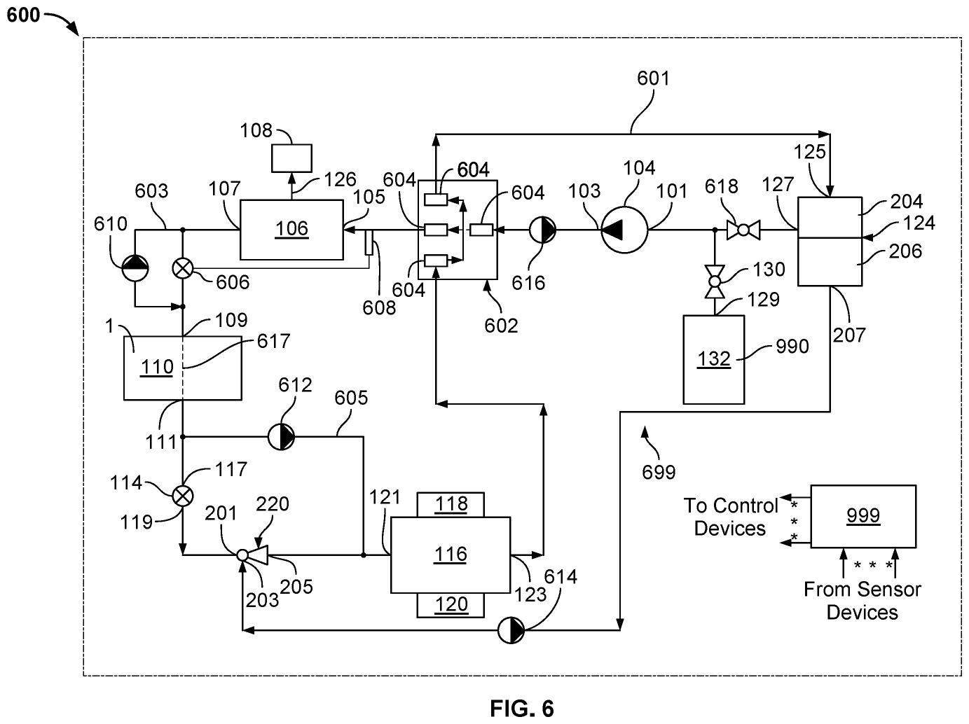

FIG. 6 shows another schematic diagram of an example implementation of a thermal management system (TMS) 600 that includes a CCRS 699 with the IL 990 in absorber/desorber 132 along with a closed circuit heat pump system. The TMS 600 provides closed-circuit refrigeration for low heat loads over long time intervals and/or refrigeration of high heat loads over short time intervals (relative to the amount of heat and the interval of refrigeration of low heat load), and at times, a heating capacity such as to bring a cooling apparatus up to a proper operating temperature.

As shown in FIG. 6, CCRS 699 includes receiver 110 configured to store refrigerant fluid, electronically controllable expansion valves 606 and 114, an evaporator 116, an optional ejector assisted circuit, and a liquid separator 124. In alternative implementations of CCRS 699, the optional ejector assist circuit is not included and the liquid separator 124 is a suction accumulator 124. Thus, in some aspects, the outlet 119 of the expansion valve 114 is connected to the inlet 121 of the evaporator 116, the inlet 125 of the suction accumulator 124 is connected through conduit 601 to a port 604 of a four-way valve 602, and the outlet 127 of the suction accumulator 124 is connected to optional solenoid valve 618.

In some aspects, the receiver 110 is configured to allow exit of the liquid phase refrigerant in both cooling and heating modes. That is, the receiver inlet 109, e.g., a tube entering from the top (inlet in the cooling mode) is extended to the receiver bottom and does not interfere with the receiver outlet 111, e.g., another tube attached to the bottom (exit in the cooling mode). This can be achieved, for example, by installation of a vertical divider 617 between the openings in the receiver 110. The vertical divider 617 may have orifices/perforation, or a gap between edges and the receiver sides, or other means to allow equalization of the refrigerant liquid level in the receiver 110.

The CCRS 699 also includes junctions, the compressor 104, the absorber/desorber 132 and optionally the solenoid control valve 130 (coupled near bidirectional port 129), and the condenser 106 (or other suitable gas cooler for use in a trans-critical refrigeration system), all of which are coupled via conduit. An optional solenoid control valve (not shown) can be used when the expansion valves 606 and 114 are not configured to completely stop refrigerant flow according to the TMS 600 operational state. The absorber/desorber 132 and optional solenoid control valve 130 are coupled, via junction, between the vapor-side outlet 127 of the suction accumulator 124 and the compressor inlet 101, as shown.

The CCRS 699 also includes the four-way valve (reversing valve) 602 having ports 604 (four total). The four-way valve 602 is configurable to permit any of the four ports 604 to couple to any one of the other ports 604. The four-way valve 602 changes direction of refrigerant flow. The CCRS 699 also includes check valve 610 in conduit 603 and check valve 612 in conduit 605. In examples that do not include the ejector assist circuit, the check valve 612 can be coupled in conduit 603 in parallel with the expansion valve 114 (with the check valve 612 having an inlet coupled to the outlet 119 at a junction, and an outlet coupled to the inlet 117 at a junction).

The check valves 610 and 612 are unidirectional valves, meaning that a fluid can flow in one direction through the valve, but is blocked from flowing in the opposite direction. The check valves 610 and 612 allow bypass of the expansion valves 606 and 114 (respectively) when refrigerant flows reverse direction. The check valve 616 is optional. Check valve 616 does not have a material impact on switching operations, but instead is present to prevent back flow of liquid into the compressor outlet 103. For those compressors that have built in inlet and outlet check valves, the built-in outlet check value can be used in lieu of check valve 616. For a compressor 104 that had a check valve at the outlet 103, the presence of two check valves may cause a conflict, and thus the check valve 616 would not be used. The CCRS 699 may include an oil separator (not shown). Also, a check valve can be integrated with the oil separator OS. This valve does not have an impact on switching operation from cooling to heating.

In FIG. 6, the convention used to denote fluid flow in the check valves is that the dark solid portion of the check valve is the port of the valve that permits intake of fluid, i.e., the inlet port, with the other port outputting fluid, i.e., the outlet port, but blocking intake of fluid.

TMS 600 includes the compressor circuit to cool low heat load 120 that operates over long (or continuous) time intervals and/or high heat load 118 (shown with the evaporator 116). In the implementations depicted, some or all of the control devices such as the expansion valves 606 and 114, the motor of the compressor 104, etc. are controlled by control signals produced by a controller 999.

The CCRS 699 can operate in a cooling mode. When the CCRS 699 is switched into the cooling mode, the CCRS 699 provides refrigerant fluid to the evaporator 116 to cool the low heat load 120 and/or high heat load 118. In the cooling mode, the CCRS 699 has the compressor 104 forcing a high pressure, high temperature refrigerant vapor received at the compressor inlet 101, via the junction and the optional solenoid control valve 618, from the vapor-side outlet 127 of the suction accumulator 124, through the check valve 616 and into a port 604 of the four-way valve 602. Excess refrigerant vapor received at the compressor inlet 101 is absorbed by the absorber/desorber 132. The controller 999 (or other mechanism) causes the four-way valve 602 to deliver the high pressure, high temperature refrigerant vapor flow out of a port 604 of the four-way valve 602 to the inlet 105 of the condenser 106. The fan 108 (or pump) is used to transport ambient air 126 or other cooling media across the condenser 106. This air 126 will be at a cooler temperature than the vapor so the air carries away thermal energy (heat) from the high pressure, high temperature refrigerant vapor flow. The high pressure, high temperature refrigerant vapor flow condenses as it loses its thermal energy and leaves the condenser 106 as a high pressure, lower temperature liquid refrigerant.

The high pressure, lower temperature liquid refrigerant is fed into the junction towards the expansion valve 606 that is in a closed state. This high pressure, lower temperature liquid refrigerant therefore bypasses the expansion valve 606 and flows through the check valve 610 through conduit 603 that is positioned to allow fluid flow. The high pressure, lower temperature liquid refrigerant from the check valve 610 is fed into an inlet 109 of the receiver 110 via the connection of the check valve 616 with a junction.

From the outlet 111 of the receiver 110, liquid refrigerant flows into the junction with the check valve 612 in a position that blocks or checks fluid flow and the expansion valve 114 placed in an “on state,” so that the liquid refrigerant from the receiver 110 passes through the junction and into the expansion valve 114. As the liquid refrigerant from the receiver 110 passes through the expansion valve 114, the refrigerant undergoes expansion changing to a part liquid, part vapor refrigerant fluid mixture, which causes a drop in pressure and temperature of the refrigerant fluid. This part liquid, part vapor refrigerant fluid mixture passed through a junction and is fed to an inlet 121 of the evaporator 116, where the refrigerant at the lower pressure and temperature causes a heat transfer from the low heat load 120 and/or high heat load 118 into the refrigerant fluid, causing the refrigerant fluid to boil, and remove heat from the low heat load 120 and/or high heat load 118. The refrigerant fluid now mostly vapor leaves the evaporator 116 at evaporating pressure, possibly with a superheat, and flows into a port 604 of the four-way valve 602. The four-way valve 602 diverts this refrigerant fluid flow into a port 604 of the four-way valve 602 and into inlet 125 of the suction accumulator 124, and from the suction accumulator 124, the refrigerant fluid vapor is fed back into the compressor 104 via the junction to repeat the cycle.

The absorber/desorber 132 (with the optional solenoid control valve 128) operates as follows. In a first example mode of operation, the heat load 120 and/or heat load 118 correspond to compressor pumping capacity, and the compressor 104 processes all vapor formed in the evaporator 116. The absorber/desorber 132 neither absorbs nor generates any refrigerant vapor. In a second example mode of operation, the heat loads 120 and/or heat load 118 exceed the compressor flow pumping capacity, and a portion of vapor formed in the evaporator 116 is induced by the compressor 104. The remaining portion is absorbed by the IL 990 in the absorber/desorber 132 operating as an absorber. When the heat from heat loads 120 and/or 118 on the evaporator 116 increases, the superheat generated at the evaporator outlet 123 increases as well. In response, the expansion valve 114 increases the orifice opening and the flow rate through the evaporator 116 to satisfy the increased heat load and the increased superheat. When the flow rate exceeds the compressor pumping capacity, the evaporating and suction pressures concomitantly increase, destroying the refrigerant vapor—ionic liquid equilibrium. The excessive amount of formed refrigerant vapor at the outlet of the evaporator 116 is absorbed, via the junction 130f diverting refrigerant vapor into the IL 990 in the absorber/desorber 132 until the equilibrium is re-established at the increased evaporating pressure. The receiver 110 is sized to sustain the increased refrigerant mass flow rate demand in this case.

In a third example mode of operation, the heat from heat loads 120 and/or 118 on the evaporator 116 decreases, and the superheat at the evaporator outlet decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor, via the junction 130f that was desorbed from the absorber/desorber 132 into the receiver 110 until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator. If the heat loading is small, the additional optional solenoid control valve 128 may be open to allow circulation of the evaporator to cool the heat loads. The TMS 600 may also include the optional solenoid control valve 128 coupled between the compressor inlet 101 and vapor-side outlet 127, used to expedite desorption of refrigerant vapor from IL 990, as discussed above.

The CCRS 699 can operate in a heating mode. At times, the TMS 600 may have components that need to have heat applied for operation, e.g., need the capability to bring a cold plate (or other cooling apparatus such as an evaporator) up to a proper operating temperature. When the CCRS 699 is switched into the heating mode, the CCRS 699 provides heating functionality to the evaporator 116 (i.e., in a heat pump mode). With the low heat load 120 and/or the high heat load 118 applied, the TMS 600 is configured to have the CCRS 699 provide heat to the low heat load 120 and/or the high heat load 118 through the evaporator 116.

In the heating mode, the CCRS 699 has the compressor 104 forcing a high pressure, high temperature refrigerant vapor received from the vapor-side outlet 127 of the suction accumulator 124, through the check valve 616 and into a port 604 of the four-way valve 602, i.e., the “reversing valve.” The four-way valve 602 feeds the high pressure, high temperature refrigerant vapor flow out of another port 604 to the evaporator 116, operating as a condenser (in heat pump mode). The high pressure, high temperature refrigerant vapor transfers heat to the evaporator 116 (acting as a condenser) holding the low heat load 120 and/or the high heat load 118 or to another item that needs to be heated. The refrigerant leaves the evaporator 116, as a high pressure, lower temperature state and flows into the junction and through the check valve 612 (connected in parallel only with the expansion valve 114 in examples without the ejector assist circuit) that is positioned in a direction to allow refrigerant flow, while the expansion valve 114 is in a closed state, which causes the refrigerant flow to bypass the expansion valve 114. The refrigerant is fed into the receiver 110, via the outlet 111 (acting as an inlet in heat pump mode).

The check valve 610 is positioned in a direction that blocks or checks fluid flow, causing liquid refrigerant received from the receiver 110 to pass through the expansion valve 606 and enter the outlet 107 of the condenser 106 which is operating as an evaporator (in heat pump mode). The fan 108 or other transport mechanism used to transport ambient air 126 across the condenser 106 is on in this mode. The refrigerant passes through the inlet 105 of the condenser 106 into a port 604 of the four-way valve 602. The four-way valve 602 diverts this refrigerant flow into another port 604 of the four-way valve 602 and into the inlet 125 of the suction accumulator 124 and from the suction accumulator 124 back into the compressor 104 via the vapor-side outlet 127 to repeat the circuit.

The CCRS 699 generally also includes the controller 999 that produces control signals (based on sensed thermodynamic properties) to control operation of various devices, such as expansion valves 606 and 114, the four-way valve 602, etc., as needed, as well as the motor for the compressor 104, etc. Controller 999 may receive signals, process received signals and send signals (as appropriate) from/to the expansion valves 606, 114, and the motor of the compressor 104, changing its speed, shutting it off, or starting it, for example.

As shown, an optional ejector assist circuit is shown in CCRS 699. In this optional example, the CCRS 699 also includes the ejector 220 that has the primary inlet 201, the secondary inlet 203 and the ejector outlet 205. The primary inlet 201 is coupled to an outlet 119 of the expansion valve 114 and the secondary inlet 203 is coupled to an outlet of a check valve 614. The ejector outlet 205 is coupled to the inlet 121 of the evaporator 116. An inlet of the check valve 614 is coupled to the liquid-side outlet 207 of, in this example, a liquid separator 124.

In the CCRS 699 with ejector assist circuit, there are two different modes of operation. One mode is a cooling and the other mode is a heating mode as In a cooling mode, the CCRS 699 cools the low heat load 120 and/or high heat load 118. The controller 999 produces signals to cause the CCRS 699 to provide cooling functionality to the evaporator 116. In the cooling mode, the CCRS 699 has the compressor 104 forcing a high pressure, high temperature refrigerant vapor received from the vapor-side outlet 127 through the check valve 616 and into a port 604 of the four-way valve 602, as previously discussed. The controller 999 (or other mechanism) causes the four-way valve 602 to deliver the high pressure, high temperature refrigerant vapor flow out of a port 604 of the four-way valve 602 to the inlet 105 of the condenser 106. A fan or other mechanism (not shown) is used to transport ambient air or other cooling media across the condenser 106. This air will be at a cooler temperature than the vapor so the air carries away thermal energy (heat) from the high pressure, high temperature refrigerant vapor flow. The high pressure, high temperature refrigerant vapor flow condenses as it loses its thermal energy and leaves the condenser 106 as a high pressure, lower temperature liquid refrigerant.

The high pressure, lower temperature liquid refrigerant is fed towards the expansion valve 606 that is in a closed state. The high pressure, lower temperature liquid refrigerant bypasses the expansion valve 606 due to the presence of the check valve 610 that is positioned in a direction to allow fluid flow. The high pressure, lower temperature liquid refrigerant from the check valve 610 is fed into the inlet of the receiver 110. At the outlet 111 of the receiver 110, the check valve 612 (in conduit 605) is positioned to block or check fluid flow and the expansion valve 114 is in an on state. Thus, the liquid refrigerant from the receiver 110 passes through the expansion valve 114. As the liquid refrigerant from the receiver 110 passes through the expansion valve 114 that is in the open state, the refrigerant changes to a part liquid, part vapor refrigerant fluid mixture which causes a drop in pressure and temperature of the refrigerant fluid. This part liquid, part vapor refrigerant fluid mixture from the expansion valve 114 is fed to the primary inlet 201. The liquid-side outlet 207 of the liquid separator 124 is coupled to the secondary inlet 203 (low-pressure inlet) of the ejector 220.

The pressure in the evaporator 116 depends on the evaporating temperature, which is lower than the heat load temperature, and is defined during design of the system, as well as subsequent recirculation of refrigerant from the check valve 614, which secondary flow is entrained by the primary flow. In this configuration, the ejector 220 acts as a “pump,” to “pump” a secondary fluid flow, e.g., liquid from the liquid-side outlet 207 of the liquid separator 124, which passes through check valve 614 using energy of the primary refrigerant flow from the expansion valve 114. The liquid refrigerant fed to the ejector 220 is expanded at a constant entropy in the ejector 220 (in an ideal case; in reality the nozzle is characterized by the ejector isentropic efficiency), and turns into a two-phase (gas/liquid) state. The refrigerant in the two-phase state exits the ejector outlet 205 and enters the evaporator 116. The evaporator 116 provides cooling duty and discharges the refrigerant in a two-phase state at an exit vapor quality (fraction of vapor to liquid) below a unit vapor quality (“1”).

In the evaporator 116, the refrigerant is at the lower pressure and temperature, and captures heat from the low heat load 120 causing a heat transfer from the low heat load 120 into the refrigerant fluid that boils and thus removes heat from the heat load. The refrigerant fluid now mostly vapor leaves the evaporator 116 as a low pressure, lower temperature, at a vapor quality at almost 1 (the critical vapor quality, discussed below), and flows into a port 604 of the four-way valve 602. The four-way valve 602 diverts this refrigerant fluid flow into another port 604 of the four-way valve 602 and to the liquid separator 124, and from the liquid separator 124 refrigerant fluid vapor is fed back into the compressor 104 to repeat the circuit. The absorber/desorber 132 (with the optional solenoid control valve 128), operates as previously discussed (in the three example modes).

CCRS 699 with the ejector assist circuit can operate in a heating mode. At times, the TMS 600 may have components that need to have heat applied for operation, as explained above. In a heating mode, the CCRS 699 is configured to provide heat to the low heat load 120 (or the high heat load 118) through the evaporator 116. In this mode, the evaporator 116 operates as a condenser at a high (discharge or condensing) pressure that is maintained from the compressor discharge at the outlet to the expansion valve 114. The CCRS 699 has the compressor 104 forcing a high pressure, high temperature refrigerant vapor from the vapor-side outlet 127 of the liquid separator 124 through the check valve 616, and into a port 604 of the four-way valve 602, i.e., “reversing valve.” The four-way valve 602 feeds the high pressure, high temperature refrigerant vapor flow out of another port 604 of the four-way valve 602 to the evaporator 116 (at outlet 123 in heat pump mode). The evaporator 116 operates as a condenser in this heating mode, by condensing the high pressure refrigerant and rejecting heat to the low heat load 120 requiring heating. That is, the high pressure, high temperature refrigerant vapor transfers heat to the low heat load 120.

The refrigerant leaves the evaporator 116 as a high pressure, lower temperature state and flows into the check valve 612 that is positioned in a direction to allow refrigerant flow, while the expansion valve 114 is in a closed state, which causes the refrigerant flow to bypass the expansion valve 114 and the ejector 220. The refrigerant is fed to the receiver 110 (to the outlet 111, acting as inlet in heat pump mode). The check valve 610 is positioned in a direction that blocks or checks fluid flow, causing liquid refrigerant from the receiver 110 to pass through the expansion valve 606 and into the condenser 106 (through outlet 107).

Liquid at the high pressure is expanded in the expansion valve 606 (controlled by sensor 608) at a constant enthalpy, turns into liquid and vapor mixture at the low pressure, and the mixture fills the condenser 106. In the condenser 106, operating as an evaporator, the refrigerant evaporates at low pressure. A port 604 of the four-way valve 602 receives the refrigerant flow and diverts this refrigerant flow to the liquid separator inlet 125, and from the liquid separator 124 into the optional solenoid control valve 618 and to the compressor 104 to repeat the circuit. The TMS 600 may also include the optional solenoid control valve 618 used to expedite desorption of refrigerant vapor from IL, as discussed above.

In this mode, the condenser 106 operates as an evaporator and a low (suction or evaporation) pressure (relative to the high pressure at the evaporator 116) is maintained from the expansion valve 606 connected to the condenser 106 to the compressor suction. The expansion valve 606 controls expansion (with sensor 608) to provide a superheat at the condenser inlet (which in this heating mode is the evaporator outlet) to avoid accumulation of liquid in the liquid separator 124 during the heating mode. When closed, additional optional solenoid control valves (or check valves) separate the high and low pressure zones.

The CCRS 699 can also operate with dual ejector assist circuits. One ejector assist circuit is as shown in FIG. 6, while a second ejector assist circuit is positioned between the inlet 109 of the receiver 110 and the outlet 107 of the condenser 106. For example, a second ejector 220 can have a primary (suction) inlet 201 fluidly coupled to the inlet 109 of the receiver 110 through expansion valve 606, a secondary (motive) inlet 203 fluidly coupled to the liquid outlet 207 of the liquid separator 124 (through an optional solenoid control valve). An ejector outlet 205 of the second ejector 220 is fluidly coupled to the outlet 107 of the condenser 106. In this example, check valve 606 in conduit 503) is coupled between the inlet 109 (of receiver 110) and expansion valve 606 (at one end) and between ejector outlet 205 and outlet 107 (at the other end)

In a dual ejector configuration, CCRS 699 can have two different modes of operation. One mode is a cooling mode as previously described (with the second ejector 220 and expansion valve 606 bypassed), which has two sub-modes, and the other mode is a heating mode as previously described (with the first, illustrated ejector 220 and expansion valve 114 bypassed. In a dual ejector configuration, during cooling, the first ejector 220 (shown in FIG. 6) and the expansion valve 114 are engaged, whereas the expansion valve 606 and a second ejector 220 are bypassed. During heating, the first ejector 220 and the expansion valve 114 are bypassed as previously described, whereas the expansion valve 606 and a second ejector 220 are engaged. In a heating operation, a primary (suction) inlet 201 of the second ejector 220 is fed by the outlet of the expansion valve 606. The check valve 610 bypasses the second ejector 220 and the expansion valve 606 during a cooling mode of operation. In some implementations, some or all of the devices such as valves, compressor, etc. are controlled by control signals produced by a controller 999.

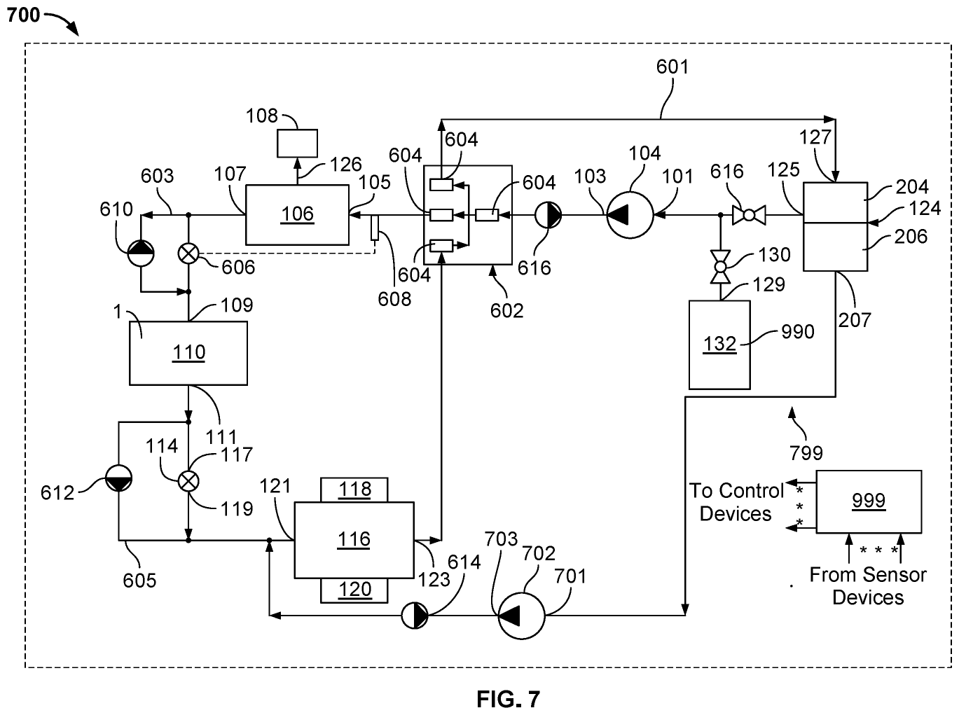

FIG. 7 shows another schematic diagram of an example implementation of a thermal management system (TMS) 700 that includes a CCRS 799 with the IL 990 in absorber/desorber 132 along with a closed circuit heat pump system and pump assist circuit. The TMS 700 provides closed-circuit refrigeration operation for low heat loads over long time intervals and refrigeration for high heat loads over short time intervals (relative to the amount of heat and the interval of refrigeration of low heat load) and at times a heating capacity to bring a cooling apparatus up to a proper operating temperature. Features illustrated but not mentioned below are mentioned in previously described figures, above and in general will function in a similar manner, unless otherwise noted. CCRS 799 can operate in both a cooling and heating mode, with operations similar to those described with reference to FIG. 6 for such operations.

The CCRS 799 also includes pump 702 that has an inlet 701 and an outlet 703. In the illustrated example, inlet 701 is fluidly coupled to the liquid-side outlet 207 of the liquid separator 124. The outlet 703 is coupled through a check valve 614 to a junction at the inlet 121 of the evaporator 116. As previously described, check valve 612 bypasses the expansion valve 114 when refrigerant flow is reversed for a heating operation, while check valve 610 bypasses expansion valve 606 when refrigerant flow is directed for a cooling operation. Sensor 608 is disposed at the condenser inlet 105 to measure a thermodynamic property of the refrigerant fluid flow between the condenser 106 and the four-way valve 602 during heating operations to control the opening of expansion valve 606 as previously described.

In a heating mode, the pump 702 can operate across a reduced pressure differential (pressure difference between inlet and outlet of the pump 702). During start-up. CCRS 799 needs to charge the evaporator 116 with liquid refrigerant. By placing the evaporator 116 between the outlet 119 of the expansion valve 114 and the inlet 125 of the liquid separator 124, this configuration has the necessity of having liquid refrigerant first pass through the liquid separator 124 during the initial charging of the evaporator 116 with the liquid refrigerant. At the same time, liquid refrigerant that is trapped in the liquid separator 124 may be wasted after the CCRS 799 shuts down.

Various types of pumps can be used for pump 702. Exemplary types include gear, centrifugal, or rotary-vane, types, etc. When choosing a pump the pump should be capable to withstand the expected fluid flows, including criteria such as temperature ranges for the fluids, and materials of the pump should be compatible with the properties of the fluid. A subcooled refrigerant can be provided at the pump 702 outlet to avoid cavitation. To do that a certain liquid level in the liquid separator 124 may provide hydrostatic pressure corresponding to that sub-cooling.

In a cooling mode, CCRS 799 operated similarly to CCRS 699 (without the ejector or dual ejector assist circuits). In a cooling mode, the liquid separator 124 receives the discharge refrigerant from the four-way valve 602 and separates the discharge refrigerant with only or substantially only liquid exiting the liquid separator at liquid-side outlet 207 to be pumped by pump 702, and only or substantially only vapor exiting the liquid separator 124 at vapor-side outlet 127 to be compressed by the compressor 104, repeating the previously described circuit.

In a heating mode, CCRS 799 operated similarly to CCRS 699 (without the ejector or dual ejector assist circuits). However, check valve 614 prevents backflow of refrigerant from the junction at the inlet 121 (i.e., from the evaporator 116 operating as a condenser in heat pump mode) to flow into the outlet 703 of the pump 702.

In a modified configuration of CCRS 799, there can be a pump assist circuit with plural pump lines. For example, the pump 702 can be positioned such that the inlet 701 is still fluidly coupled to the liquid outlet 207 of liquid separator 124, but the outlet 703 of the pump 702 is fluidly coupled to the inlet 121 of the evaporator 116 through check valve 614 as shown in a first pump line, and also to the outlet 107 of the condenser 106 through another conduit and check valve in a second pump line (not shown). Alternatively, the pump 702 can be positioned such that the inlet 701 is still fluidly coupled to the liquid outlet 207 of liquid separator 124, but the outlet 703 of the pump 702 is fluidly coupled to the outlet 111 of the receiver 110 through check valve 614 as shown in a first pump line (bypassing the check valve 612 and the expansion valve 114), and also to a junction adjacent the inlet 109 of the receiver 110 through another conduit and check valve in a second pump line (not shown).

In such modified configurations, the provision of two pump lines can cause the condenser 106 to operate either as a condenser or an evaporator, as discussed below, and can cause the evaporator 116 to operate either as an evaporator or a condenser across a reduced pressure differential. The dual lines two parallel lines operating equally in both, heating and cooling modes and, therefore, one of them can be deleted. The receiver 110 must be configured to allow exit of liquid in cooling and heating modes as described above.

In a cooling mode, the modified configurations can operate as previously described (with expansion device 114 in operation and expansion device 606 bypassed). In a heating mode, the evaporator 116 operates as a condenser at a high (discharge or condensing) pressure that is maintained from the compressor 104 discharge at the outlet to the expansion valve 606, as previously described. In particular, in these modified configurations, check valve 614 checks or blocks refrigerant flow leaving the evaporator 116 (leaving the inlet 121 in heat pump mode) from entering the outlet 703 of the pump 702.

FIG. 8 shows another schematic diagram of an example implementation of a thermal management system (TMS) 800 that includes a CCRS 899 with the IL 990 in absorber/desorber 132 along with a multi-evaporator closed-circuit refrigeration system that cools a high temperature load and a low heat and/or high heat loads. The CCRS 899 includes two interacting circuits, a vapor compression closed-circuit refrigeration system and a closed-circuit pumping system. The vapor compression closed-circuit refrigeration system is configured to cool low heat loads 120 and/or high heat load 118 that are below the condensation temperature of a refrigerant vapor, whereas the closed-circuit pumping system cools high temperature heat loads 810 that are at a high temperature equal to or above the condensation temperature of the refrigerant vapor. Examples of high temperature heat loads are batteries and various electronic and mechanical devices.

The vapor compression closed-circuit refrigeration system includes the receiver 110 that has the outlet 111 coupled to a junction and inlet 113 of optional solenoid valve 112. The optional solenoid control valve 112 has an outlet 115 that is coupled to an inlet 117 of a control device, such as the expansion valve 114. The optional solenoid control valve 112 can be used when the expansion valve 114 is not configured to completely stop refrigerant flow when the TMS 800 is in an off state. The CCRS 899 also includes the absorber/desorber 132 (with the optional solenoid control valve 130) coupled via junction to receive vapor from the outlet 123 of the evaporator 116.

The expansion valve 114 has an outlet 119 that is coupled to an inlet 121 of a vapor-circuit evaporator, i.e., the evaporator 116. The evaporator 116 has an outlet 123 that is coupled to a compressor inlet 101 of the compressor 104 and the junction that is coupled to the absorber/desorber 132. The compressor 104 has the compressor outlet 103 coupled through a check valve 806 to an inlet of a junction that has an outlet that is coupled to the condenser inlet 105 of the condenser 106 and the condenser outlet 107 is coupled to the receiver inlet 109 of the receiver 110. Conduit couples the aforementioned devices, as shown.

The condenser 106 of the vapor compression closed-circuit refrigeration system can be air cooled, water cooled, or use any cooling fluid available in the vehicle or station where the system is installed. Not shown is an optional bypass coupled between the receiver inlet and the inlet to a second evaporator, e.g., a closed-circuit evaporator. The bypass can include a control valve and two additional junctions.

The closed-circuit pumping system includes the receiver 110 and the junction that has a second outlet coupled to an inlet 701 of a recirculation pump 702 (multi-speed or variable speed). The outlet 703 of the recirculation pump 702 is coupled to an optional solenoid control valve 804 in conduit 803 that is coupled to a closed-circuit evaporator 802 that houses a device to be cooled, i.e., a high temperature heat load 810, e.g. a battery, electronic circuits, etc. From the outlet of the closed-circuit evaporator 802 refrigerant fluid passes to an inlet of a second check valve 808 in conduit 801 and back to a second inlet of the junction to the inlet 105 of the condenser 106. Conduit couples the aforementioned devices, as shown.

Normally, the evaporator 116 of the vapor compression closed-circuit refrigeration system generates a superheat at the exit thereof. The expansion valve 114 can be configured to control vapor quality at the evaporator outlet. (Alternatively an ejector or a pump can be used to control vapor quality, as discussed below.) The vapor compression closed-circuit refrigeration system with the recirculation pump 702 recirculates liquid refrigerant and can be configured to control two-phase (or superheated) refrigerant states exiting the evaporator 116.

In some embodiments, the recirculation pump 702 is a variable speed or multi-speed pump. The TMS 800 may implement several methods of temperature control. For example, one method of temperature control involves varying the speed of the recirculation pump 702, e.g., the variable speed or multi-speed pump. Another example involves modulating a control valve (not shown) on the main line from the receiver 110 (between receiver outlet 111 and junction between pump 702 and valve 112). Various combinations of the above examples can also be used. In some implementations of the multi-evaporator closed-circuit refrigeration system, an oil is used for lubrication of the compressor 104. The oil is separated from the refrigerant and returned to the compressor, as discussed above.

An advantage of the TMS 800 is that cooling of electronics, such as batteries is implemented without upsizing the compressor 104. Upsizing the compressor 104 to cool the battery at the same evaporating temperature as the low heat load 120 and/or the high heat load 118 would require a larger and heavier system.

When the low heat load 120 is active, the CCRS 899 is configured to have the vapor compression closed-circuit refrigeration system provide refrigeration to the low heat load 120 and/or high heat load 118. In this instance, a controller 999 produces signals to open the optional solenoid control valve 112 (if used). In the vapor compression closed-circuit refrigeration system, circulating refrigerant enters the compressor 104 as a saturated or superheated vapor and is compressed to a higher pressure at a higher temperature (a superheated vapor). This superheated vapor is at a temperature and pressure at which it can be condensed in the condenser 106 by either cooling water or cooling air 126 flowing across a coil or tubes in the condenser 106. At the condenser 106, the circulating refrigerant loses heat and thus removes heat from the TMS 800, which removed heat is carried away by either water or air (whichever may be the case) flowing over the coil or tubes, providing a condensed, sub-cooled liquid refrigerant.

The condensed, sub-cooled liquid refrigerant is routed into the receiver 110, exits the receiver 110, and enters the expansion valve 114 (through the optional solenoid control valve 112, if used.) The liquid refrigerant is enthalpically expanded in the expansion valve 114 and the high pressure sub-cooled liquid refrigerant turns into a liquid-vapor mixture at a low pressure and temperature. The temperature of the liquid and vapor refrigerant mixture (evaporating temperature) is lower than the temperature of the low heat load 120. The mixture is routed through a coil or tubes in the evaporator 116.

The heat from the low heat load 120, in thermal conductive or convective contact with or proximate to the evaporator 116, partially (provided that another mechanism is used to ensure that liquid does not enter the compressor 104 inlet) or completely evaporates the liquid portion of the two-phase refrigerant mixture and superheats the mixture. The saturated or superheated refrigerant vapor leaves the evaporator 116 and enters the compressor 104. If the evaporator 116 operates in a threshold of vapor quality, a suction accumulator (not shown) captures liquid and slowly returns it back into the suction line. Compressed vapor exits the compressor 104, passes though the check valve 806 and enters the junction. The evaporator 116 is where the circulating refrigerant absorbs and removes heat from the applied low heat load 120, which heat is subsequently rejected in the condenser 106 and transferred to an ambient by water or air used in the condenser 106.

The closed-circuit pumping system operates as follows: The recirculation pump 702 is turned on causing refrigerant from the receiver 110, via the outlet of the junction, to be pumped by the recirculation pump 702 through the optional solenoid control valve 804 (that is open) and into the inlet of the closed-circuit evaporator 802 that has the high temperature heat load 810, e.g., a battery for high temperature cooling (cooling at a temperature at or above condensation temperature of the refrigerant vapor). Heat from the high temperature heat load 810 is removed into the refrigerant liquid and the refrigerant liquid carries the heat through the check valve 808 into the junction and to the inlet 105 of the condenser 106. The closed-circuit evaporator 802 is where the circulating refrigerant absorbs and removes heat from the high temperature heat load 810, which heat is subsequently rejected in the condenser 106, and transferred to an ambient by water or air 126 used in the condenser 106.

The absorber/desorber 132 (with the optional solenoid control valve 130), operates as follows. In a first example mode of operation, the heat load 120 and/or 118 correspond to compressor pumping capacity, and compressor 104 processes all vapor formed in the evaporator 116. The absorber/desorber 132 neither absorbs nor generates any refrigerant vapor. In a second example mode of operation, the heat loads 120 and/or 118 exceed the compressor flow pumping capacity, and a portion of the vapor formed in the evaporator 116 is induced by the compressor 104. The remaining portion is absorbed by the IL 990 in the absorber/desorber 132 operating as an absorber. When the heat from heat loads 120 and/or 118 on the evaporator 116 increases, the superheat generated at the evaporator outlet increases as well. In response, the expansion valve 114 increases the orifice opening and the flow rate through the evaporator 116 to satisfy the increased heat load and the increased superheat. When the flow rate exceeds the compressor pumping capacity, the evaporating and suction pressures concomitantly increase, destroying the refrigerant vapor—ionic liquid equilibrium. The excessive amount of formed refrigerant vapor at the outlet of the evaporator 116 is absorbed by the IL 990 in the absorber/desorber 132 until the equilibrium is re-established at the increased evaporating pressure. The receiver 110 is sized to sustain the increased refrigerant mass flow rate demand in this case.

Heat load provided by the high temperature heat load 810 need not be absorbed by the IL 990 in the absorber/desorber 132 because high temperature heat load 810 is not coupled to the evaporator 116, and the refrigerant from the closed-circuit evaporator 802 bypasses the compressor 104.

In a third example mode of operation, the heat from heat loads 120 and/or 118 on the evaporator 116 decreases, and the superheat at the evaporator outlet 123 decreases as well. In response, the expansion valve 114 decreases the orifice opening and the flow rate through the evaporator 116 to satisfy the decreased heat load and the decreased superheat. When the flow rate is below the compressor pumping capacity, the evaporating and suction pressures concomitantly decrease, destroying the refrigerant vapor—ionic liquid equilibrium. The decreased amount of refrigerant vapor allows the compressor 104 to pump refrigerant vapor that was desorbed from the absorber/desorber 132 into the receiver 110 until the refrigerant vapor—ionic liquid equilibrium is recovered at a reduced evaporating pressure. If the heat loading is negligible or does not exist, the additional optional solenoid control valve 128 may stay closed to avoid pressure reduction in the evaporator. If the heat loading is small, the additional optional solenoid control valve 128 may be open to allow circulation of the evaporator to cool the heat loads.

In a modified configuration of CCRS 899, there can be multiple evaporators 116 and/or multiple closed-circuit evaporators 802. For example, multiple evaporators 116 (as well as corresponding solenoid valves 112 and expansion valves 114) can be piped in parallel between the outlet 111 of the receiver 110 and the optional solenoid valve 128. In some aspects, a back pressure regulator can be positioned in a conduit that connect the outlets 123 of the evaporators 116. The vapor compression closed-circuit refrigeration system in such a modified configuration is substantially identical to the vapor compression closed-circuit refrigeration system previously described, except for the provision of a second evaporator coupled in shunt with the evaporator 116, via another optional solenoid control valve and expansion valve. The back-pressure regulator acts as a flow control valve and maintains an inlet pressure at the inlet of the back-pressure regulator, so as to balance pressure flows through the multiple evaporators 116 according to a set point pressure.

In the case of multiple closed-circuit evaporators 802, multiple evaporators 802 with corresponding high temperature loads 810 (as well as corresponding solenoid valves 804) can be piped in parallel between the outlet 703 of the pump 702 and the check valve 808. In some aspects, a back pressure regulator or control valve can be positioned in a conduit that connects the outlets of the evaporators 802. The closed-circuit pumping system in such a modified configuration is substantially identical to the closed-circuit pumping system previously described, except for the provision of a second closed-circuit evaporator coupled in shunt with the closed-circuit evaporator 802, via another optional solenoid control valve. The closed-circuit pumping system in this modified configuration can also include a bypass line with a control valve and junctions coupled between the pump outlet 703 and an inlet to the check valve 808 in parallel with the multiple closed-circuit evaporators 802. The closed-circuit evaporators 802 of the closed-circuit pumping system may generate a superheat at the exit or two-phase state.

As with the illustrated example, the recirculation pump 702 can be a fixed or a variable speed or multi-speed pump. The TMS 800 in such modified configurations may implement several methods of temperature control. For example, in one method of temperature control involves varying speed of the variable speed or multi-speed recirculation pump 702. Another example involves modulating the control valve on the bypass line. Another example involves modulating a control valve (not shown) on the outlet of the receiver 110. Various combinations of the above examples can also be used.

As another example modified configuration of CCRS 899, the CCRS 899 can include a compressor economizer circuit. In a compressor economizer circuit, check valves 808 can be removed and conduit 801 can extend from an outlet of one or more closed-circuit evaporators 802 to an economizer port on compressor 104. Thus, from the outlet of the closed-circuit evaporator(s) 802, refrigerant fluid passes into an economizer port of the compressor 104.

The economizer port allows inputting vapor at an intermediate pressure that is below the discharge pressure of the compressor 104 and above the suction pressure of the compressor 104. The closed-circuit evaporator(s) 802 is where the circulating refrigerant absorbs and removes heat from the high temperature heat load(s) 810, which heat is subsequently rejected in the condenser 106, and transferred to an ambient by water or air 126 used in the condenser 106. The absorber/desorber 132 (with the optional solenoid control valve 130), operates as previously described (with example modes of operation) in this modified configuration as well. The economizer circuit can also be used with multiple evaporators 116 and/or multiple closed-circuit evaporators 802.

In another modified configuration of CCRS 899, an ejector assist circuit with an ejector (e.g., ejector 220) can be used, as described in FIG. 2. For example, an ejector 220 can be positioned with a primary (suction) inlet 201 connected to an outlet 111 of the receiver 110 (through a junction), a secondary (motive) inlet 203 connected to a liquid outlet 207 of a liquid separator 124, and an ejector outlet 205 connected to inlet 113 of optional solenoid valve 112). In some aspects, a second evaporator 116 can be positioned with an inlet 121 coupled to liquid outlet 127 of the liquid separator 124 and an outlet 123 connected to secondary inlet 203 (e.g., through another optional solenoid valve). The liquid separator 124 would be positioned with vapor outlet 127 connected to optional solenoid valve 128. The absorber/desorber 132 (with the optional solenoid control valve 130) would operate in this modified configuration as previously described as well.

In another modified configuration of CCRS 899, a pump assist circuit with a pump (e.g., pump 306) can be used, as described in FIG. 3. For example, a pump 306 can be positioned with a pump inlet 301 connected to a liquid outlet 207 of a liquid separator 124 and a pump outlet 303 connected to a junction at the outlet 111 of the receiver 110 (e.g., through an optional solenoid valve). In some aspects, a second evaporator 116 can be positioned with an inlet 121 coupled to the pump outlet 303 and an outlet 123 connected to a junction at the outlet 111 of the receiver 110 (e.g., through an optional solenoid valve). The liquid separator 124 would be positioned with vapor outlet 127 connected to optional solenoid valve 128. The absorber/desorber 132 (with the optional solenoid control valve 130) would operate in this modified configuration as previously described as well.

Referring now to FIGS. 9A-9D, additional evaporator arrangements that are alternative configurations of the evaporator 116 and heat loads 120, 118 are shown. In the configuration of FIG. 9A, both the low heat load 120 and the high heat load 118 are coupled to (or are in proximity to) a single, i.e., the same, evaporator 116. In the configuration of FIG. 9B, each of a pair of evaporators 116 have the low heat load 120 and the high heat load 118 coupled or proximate thereto. In an alternative configuration of FIG. 9B, (not shown), the low heat load 120 would be coupled (or proximate) to a first one of the pair of evaporators 116, and the high heat load 118 would be coupled (or proximate) to a second one of pair of evaporators 116.

In the configurations of FIGS. 9C and 9D, the low heat load 120 and the high heat load 118 are coupled (or proximate) to corresponding ones of the pair of evaporators 116. In the configurations of FIGS. 9C and 9D, a T-valve 902 (passive or active), as shown, splits refrigerant flow from the receiver 110, into two paths that feed two evaporators 116. One of these evaporators 116 is coupled (or proximate) to the low heat load 120 and the other of these evaporators 116 is coupled (or proximate to) the high heat load 118. As also shown in FIG. 9D, expansion valves (not referenced) are coupled at inlet sides of the evaporators 116. At least one expansion valve (not referenced) would be configured to control a vapor quality at the evaporator 116 exit to allow discharging liquid into the suction accumulator, while the other would control a superheat. Other configurations are possible.

In the configuration of FIG. 9C, the outlets of the evaporators 116 are coupled via conduits to a second T-valve 902 (active or passive) that has an outlet 123 that feeds an inlet 125 of the suction accumulator 124. On the other hand, in the configuration of FIG. 9D, the outlets 123 of the evaporators 116 are coupled differently. The outlet 123 of the evaporator 116 has low heat load 120 feeding an inlet of the second T-valve 902, whereas the outlet 123 of the evaporator 116 that has high heat load 118 feeds inlet 125 of the suction accumulator 124. This arrangement, in effect, removes the suction accumulator 124 from a path of the CCRS that includes one of the evaporators 116. In some configurations, the T valves can be switched (meaning that they can be automatically or manually controlled to shut off either or both inlets) or passive meaning that they do not shut off either inlet and thus can be T junctions.

A variety of different refrigerant fluids can be used in the example TMS described herein. Depending on the application various types of refrigerant fluids can be used.

More generally, any fluid can be used provided that the fluid is suitable for cooling, heat loads 120, 118, and high temperature heat load 810 (e.g., the fluid boils at an appropriate temperature) and, in embodiments where the refrigerant fluid is exhausted directly to the environment, regulations and other safety and operating considerations do not inhibit such discharge.

One example of refrigerant is ammonia. Ammonia under standard conditions of pressure and temperature is in a liquid or two-phase state. Thus, the receiver 110 typically will store ammonia at a saturated pressure corresponding to the surrounding temperature. The pressure in the receiver 110 storing ammonia will change during operation. The use of the various expansion valves can stabilize pressure in the receiver 110 during operation, by adjusting the control devices (e.g., automatically or by controller 999) based on a measurement of the evaporation pressure (pₑ) of the refrigerant fluid and/or a measurement of the evaporation temperature of the refrigerant fluid.

Controller 999 can adjust expansion valve 114, for example, based on measurements of one or more of the following system parameter values: the pressure drop (pᵣ-pₑ) across expansion valve 114, the pressure drop across evaporator 116, the refrigerant fluid pressure in receiver 110 (pᵣ), the vapor quality of the refrigerant fluid emerging from evaporator 116 (or at another location in the system), the superheat value of the refrigerant fluid in the system, the evaporation pressure (pₑ) of the refrigerant fluid, and the evaporation temperature of the refrigerant fluid.

To adjust expansion valve 114 based on a particular value of a measured system parameter value, controller 999 compares the measured value to a set point value (or threshold value) for the system parameter, as will be discussed below.

Since liquid refrigerant temperature is sensitive to ambient temperature, the density of liquid refrigerant changes even though the pressure in the receiver 110 remains the same. Also, the liquid refrigerant temperature impacts the vapor quality at the evaporator inlet. Therefore, the refrigerant mass and volume flow rates change and the control devices can be used.

Referring to FIG. 10, the example control system 999 includes a processor 1002, memory 1004, storage 1006, and I/O interfaces 1008, all of which are connected/coupled together via a bus 1010. Control system 999 can be used with any of the embodiments discussed herein, e.g., any of FIGS. 1 to 8.

Control system 999 can generally be implemented as any one of a variety of different electrical or electronic computing or processing devices, and can perform any combination of the various steps discussed above to control various components of the disclosed thermal management systems.

Control system 999 can generally, and optionally, include any one or more of a processor (or multiple processors), a memory, a storage device, and input/output device. Some or all of these components can be interconnected using a system bus. The processor is capable of processing instructions for execution. In some embodiments, the processor is a single-threaded processor. In certain embodiments, the processor is a multi-threaded processor. Typically, the processor is capable of processing instructions stored in the memory or on the storage device to display graphical information for a user interface on the input/output device, and to execute the various monitoring and control functions discussed above. Suitable processors for the systems disclosed herein include both general and special purpose microprocessors, and the sole processor or one of multiple processors of any kind of computer or computing device.

The memory stores information within the system, and can be a computer-readable medium, such as a volatile or non-volatile memory. The storage device can be capable of providing mass storage for the control system 999. In general, the storage device can include any non-transitory tangible media configured to store computer readable instructions. For example, the storage device can include a computer-readable medium and associated components, including: magnetic disks, such as internal hard disks and removable disks; magneto-optical disks; and optical disks. Storage devices suitable for tangibly embodying computer program instructions and data include all forms of non-volatile memory including by way of example, semiconductor memory devices, such as EPROM, EEPROM, and flash memory devices; magnetic disks such as internal hard disks and removable disks; magneto-optical disks; and CD-ROM and DVD-ROM disks. Processors and memory units of the systems disclosed herein can be supplemented by, or incorporated in, ASICs (application-specific integrated circuits).

The input/output device provides input/output operations for control system 999, and can include a keyboard and/or pointing device. In some embodiments, the input/output device includes a display unit for displaying graphical user interfaces and system related information.

The features described herein, including components for performing various measurement, monitoring, control, and communication functions, can be implemented in digital electronic circuitry, or in computer hardware, firmware, or in combinations of them. Methods steps can be implemented in a computer program product tangibly embodied in an information carrier, e.g., in a machine-readable storage device, for execution by a programmable processor (e.g., of control system 999), and features can be performed by a programmable processor executing such a program of instructions to perform any of the steps and functions described above. Computer programs suitable for execution by one or more system processors include a set of instructions that can be used directly or indirectly to cause a processor or other computing device executing the instructions to perform certain activities, including the various steps discussed above.

Computer programs suitable for use with the systems and methods disclosed herein can be written in any form of programming language, including compiled or interpreted languages, and can be deployed in any form, including as stand-alone programs or as modules, components, subroutines, or other units suitable for use in a computing environment.

In addition to one or more processors and/or computing components implemented as part of control system 999, the systems disclosed herein can include additional processors and/or computing components within any of the control device (e.g., solenoid control valves) and any of the sensors discussed above. Processors and/or computing components of the control devices and sensors, and software programs and instructions that are executed by such processors and/or computing components, can generally have any of the features discussed above in connection with control system 999. Any two of devices, such as pressure sensors, upstream and downstream from a control device, can be configured to measure information about a pressure differential pᵣ−pₑ across the respective control device and to transmit electronic signals corresponding to the measured pressure from which a pressure difference information can be generated by the control system 999. Other sensors such as flow sensors and temperature sensors can be used as well. In certain embodiments, sensors can be replaced by a single pressure differential sensor, a first end of which is connected adjacent to an inlet and a second end of which is connected adjacent to an outlet of a device to which differential pressure is to be measured, such as the evaporator 116. The pressure differential sensor measures and transmits information about the refrigerant fluid pressure drop across the device, e.g., the evaporator 116.

Temperature sensors can be positioned adjacent to the evaporator inlet 121 or the evaporator outlet 123 of evaporator 116 or between the evaporator inlet 121 and the evaporator outlet 123. Such a temperature sensor measures temperature information for the refrigerant fluid within evaporator 116 (which represents the evaporating temperature) and transmits an electronic signal corresponding to the measured information. A temperature sensor can be attached to heat loads 118, 120, which measures temperature information for the heat loads 118, 120 and transmits an electronic signal corresponding to the measured information. An optional temperature sensor can be adjacent to the evaporator outlet 123 of evaporator 116 that measures and transmits information about the temperature of the refrigerant fluid as it emerges from evaporator 116.

In certain embodiments, the systems disclosed herein are configured to determine superheat information for the refrigerant fluid based on temperature and pressure information for the refrigerant fluid measured by any of the sensors disclosed herein. The superheat of the refrigerant vapor refers to the difference between the temperature of the refrigerant fluid vapor at a measurement point in the TMS 100-800 and the saturated vapor temperature of the refrigerant fluid defined by the refrigerant pressure at the measurement point in the TMS 100-800.

To determine the superheat associated with the refrigerant fluid, the control system 999 (as described) receives information about the refrigerant fluid vapor pressure after emerging from a heat exchanger downstream from evaporator 116, and uses calibration information, a lookup table, a mathematical relationship, or other information to determine the saturated vapor temperature for the refrigerant fluid from the pressure information. The control system 999 also receives information about the actual temperature of the refrigerant fluid, and then calculates the superheat associated with the refrigerant fluid as the difference between the actual temperature of the refrigerant fluid and the saturated vapor temperature for the refrigerant fluid.

The foregoing temperature sensors can be implemented in a variety of ways in TMS 100-800. As one example, thermocouples and thermistors can function as temperature sensors in TMS 100-800. Examples of suitable commercially available temperature sensors for use in TMS 100-800 include, but are not limited to, thermocouple surface probes.

TMS 100-800 can include a vapor quality sensor that measures vapor quality of the refrigerant fluid emerging from evaporator 116. Typically, such a sensor is implemented as a capacitive sensor that measures a difference in capacitance between the liquid and vapor phases of the refrigerant fluid. The capacitance information can be used to directly determine the vapor quality of the refrigerant fluid (e.g., by control system 999). Alternatively, sensor can determine the vapor quality directly based on the differential capacitance measurements and transmit an electronic signal that includes information about the refrigerant fluid vapor quality.

It should generally understood that the systems disclosed herein can include a variety of combinations of the various sensors described above, and control system 999 can receive measurement information periodically or aperiodically from any of the various sensors. Moreover, it should be understood any of the sensors described can operate autonomously, measuring information and transmitting the information to control system 999 (or directly to the first and/or second control device) or, alternatively, any of the sensors described above can measure information when activated by control system 999 via a suitable control signal, and measure and transmit information to control system 999 in response to the activating control signal.

To adjust a control device on a particular value of a measured system parameter value, control system 999 compares the measured value to a set point value (or threshold value) for the system parameter. Certain set point values represent a maximum allowable value of a system parameter, and if the measured value is equal to the set point value (or differs from the set point value by 10% or less (e.g., 5% or less, 3% or less, 1% or less) of the set point value), control system 999 adjusts a respective control device to modify the operating state of the TMS 100-800. Certain set point values represent a minimum allowable value of a system parameter, and if the measured value is equal to the set point value (or differs from the set point value by 10% or less (e.g., 5% or less, 3% or less, 1% or less) of the set point value), control system 999 adjusts the respective control device to modify the operating state of the TMS 100-800, and increase the system parameter value. The control system 999 executes algorithms that use the measured sensor value(s) to provide signals that cause the various control devices to adjust refrigerant flow rates, etc.

Some set point values represent “target” values of system parameters. For such system parameters, if the measured parameter value differs from the set point value by 1% or more (e.g., 3% or more, 5% or more, 10% or more, 20% or more), control system 999 adjusts the respective control device to adjust the operating state of the system, so that the system parameter value more closely matches the set point value.

Optional pressure sensors are configured to measure information about the pressure differential pᵣ−pₑ across a control device and to transmit an electronic signal corresponding to the measured pressure difference information. Two sensors can effectively measure pᵣ, pₑ. In certain embodiments two sensors can be replaced by a single pressure differential sensor. Where a pressure differential sensor is used, a first end of the sensor is connected upstream of a first control device and a second end of the sensor is connected downstream from first control device.

System also includes optional pressure sensors positioned at the inlet and outlet, respectively, of evaporator 116. A sensor measures and transmits information about the refrigerant fluid pressure upstream from evaporator 116, and a sensor measures and transmits information about the refrigerant fluid pressure downstream from evaporator 116. This information can be used (e.g., by a system controller) to calculate the refrigerant fluid pressure drop across evaporator 116. As above, in certain embodiments, sensors can be replaced by a single pressure differential sensor to measure and transmit the refrigerant fluid pressure drop across evaporator 116.

To measure the evaporating pressure (pₑ) a sensor can be optionally positioned between the inlet and outlet of evaporator 116, i.e., internal to evaporator 116. In such a configuration, the sensor can provide a direct a direct measurement of the evaporating pressure.

To measure refrigerant fluid pressure at other locations within system, sensor can also optionally be positioned, for example, in-line along a conduit. Pressure sensors at each of these locations can be used to provide information about the refrigerant fluid pressure downstream from evaporator 116, or the pressure drop across evaporator 116.

It should be appreciated that, in the foregoing discussion, any one or various combinations of two sensors discussed in connection with system can correspond to a measurement device connected to a solenoid control valve, and any one or various combination of two sensors can correspond another measurement device. In general, as discussed previously, the first measurement device provides information corresponding to a first thermodynamic quantity to the first control device, and the second measurement device provides information corresponding to a second thermodynamic quantity to the second control device, where the first and second thermodynamic quantities are different, and therefore allow the first and second control device to independently control two different system properties (e.g., the vapor quality of the refrigerant fluid and the heat load temperature, respectively).

In some embodiments, one or more of the sensors shown in system are connected directly to solenoid control valve. The first and second control devices can be configured to adaptively respond directly to the transmitted signals from the sensors, thereby providing for automatic adjustment of the system's operating parameters. In certain embodiments, the first and/or second control device can include processing hardware and/or software components that receive transmitted signals from the sensors, optionally perform computational operations, and activate elements of the first and/or second control device to adjust the control device in response to the sensor signals.

In embodiments where control devices are implemented as a device controllable via an electrical control signal, control system 999 is configured to transmit suitable control signals to the first and/or second control device to adjust the configuration of these components. In particular, control system 999 is configured to adjust an expansion valve to control the vapor quality of the refrigerant fluid in the TMS 100-800.

During operation of the TMS 100-800, control system 999 typically receives measurement signals from one or more sensors. The measurements can be received periodically (e.g., at consistent, recurring intervals) or irregularly, depending upon the nature of the measurements and the manner in which the measurement information is used by control system 999. In some embodiments, certain measurements are performed by control system 999 after particular conditions—such as a measured parameter value exceeding or falling below an associated set point value—are reached.

The thermal management systems and methods disclosed herein can be implemented as part of (or in conjunction with) directed energy systems such as high energy laser systems. Due to their nature, directed energy systems typically present a number of cooling challenges, including certain heat loads for which temperatures are maintained during operation within a relatively narrow range.

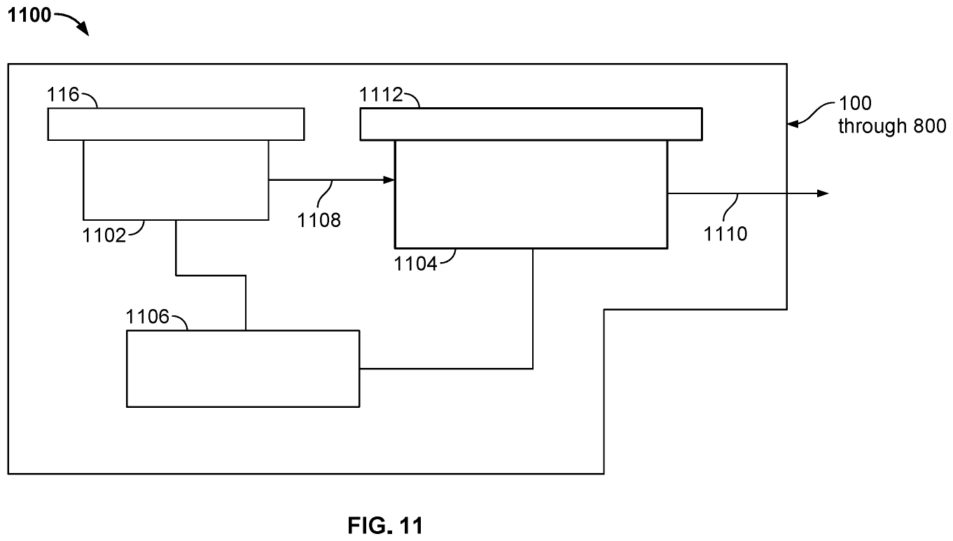

FIG. 11 shows one example of a directed energy system, specifically, a high energy laser system 1100. System 1100 includes a bank of one or more one or more laser diodes 1102 and an amplifier 1104 connected to a power source 1106. During operation, one or more laser diodes 1102 generate an output radiation beam 1108 that is amplified by amplifier 1104, and directed as output beam 1110 onto a target. Generation of high energy output beams can result in the production of significant quantities of heat. Certain laser diodes, however, are relatively temperature sensitive, and the operating temperature of such diodes is regulated within a relatively narrow range of temperatures to ensure efficient operation and avoid thermal damage. Amplifiers are also temperature-sensitively, although typically less sensitive than diodes.

To regulate the temperatures of various components of directed energy systems such as diodes 1102 and amplifier 1104, such systems can include components and features of the thermal management systems disclosed herein. In FIG. 11, evaporator 116 (FIGS. 1, etc.) is coupled to diodes 1102, while a heat exchanger 1112, (e.g., a recuperative heat exchanger such as recuperative heat exchanger 122), can be coupled to amplifier 1104. The other components of the thermal management systems disclosed herein are not shown for clarity. However, it should be understood that any of the features and components discussed above can optionally be included in directed energy systems. Diodes 1102, due to their temperature-sensitive nature, effectively function as high heat load 118 in system 1100, while amplifier 1104 functions as low heat load 120.

System 1100 is one example of a directed energy system that can include various features and components of the thermal management systems and methods described herein. However, it should be appreciated that the thermal management systems and methods are general in nature, and can be applied to cool a variety of different heat loads under a wide range of operating conditions.

A number of embodiments have been described. Nevertheless, it will be understood that various modifications may be made without departing from the spirit and scope of the disclosure. Accordingly, other embodiments are within the scope of the following claims.

What is claimed is:

1. A thermal management system, comprising:
a closed-circuit refrigeration system that comprises a closed-circuit refrigerant fluid path configured to store a refrigerant fluid; and
an absorber/desorber comprising a bidirectional port coupled to the closed-circuit refrigerant fluid path to regulate an amount of refrigerant vapor at a compressor inlet of the closed-circuit refrigeration system, the absorber/desorber configured to store an ionic liquid that is configured to absorb or desorb at least a portion of the refrigerant vapor based on a mode of operation of the absorber/desorber.

2. The thermal management system of claim 1, wherein the closed-circuit refrigeration system further comprises:
a receiver disposed in the closed-circuit refrigerant fluid path and comprising a receiver inlet and a receiver outlet,
at least one evaporator disposed in the closed-circuit refrigerant fluid path and comprising an evaporator inlet and an evaporator outlet,
at least one compressor disposed in the closed-circuit refrigerant fluid path and comprising the compressor inlet and a compressor outlet, and
at least one condenser disposed in the closed-circuit refrigerant fluid path and comprising a condenser inlet and a condenser outlet.

3. The thermal management system of claim 2, wherein the evaporator inlet is configured to receive the refrigerant fluid from the receiver, remove heat from at least one heat load by converting at least a portion of a refrigerant liquid to refrigerant vapor, and deliver the refrigerant vapor to the evaporator outlet.

4. A thermal management system, comprising:
a closed-circuit refrigeration system having a closed-circuit refrigerant fluid path that comprises;
a receiver comprising a receiver inlet and a receiver outlet, the receiver configured to store a refrigerant fluid,
at least one evaporator comprising an evaporator inlet and an evaporator outlet, the evaporator inlet configured to receive the refrigerant fluid from the receiver, remove heat from at least heat load by converting at least a portion of the refrigerant fluid to refrigerant vapor, and deliver the refrigerant vapor to the evaporator outlet
a compressor comprising a compressor inlet and a compressor outlet, and
a condenser comprising a condenser inlet and a condenser outlet; and
an absorber/desorber that comprises a bidirectional port fluidly coupled to the closed-circuit refrigerant fluid path to regulate an amount of refrigerant vapor at the compressor inlet, the absorber/desorber configured to store an ionic liquid that absorbs or desorbs refrigerant vapor according to a mode of operation of the absorber/desorber.

5. The thermal management system of claim 4, further comprising:
an expansion valve configured to expand the refrigerant fluid from the receiver into a two-phase liquid-vapor refrigerant stream.

6. The thermal management system of claim 4, further comprising a suction accumulator comprising:
an inlet coupled to the evaporator outlet, and
a vapor-side outlet coupled to the compressor inlet.

7. The thermal management system of claim 5, further comprising a sensor configured to sense a thermodynamic property of the refrigerant vapor at the evaporator outlet and produce a signal to directly or indirectly control operation of the expansion valve.

8. The thermal management system of claim 4, wherein the ionic liquid in the absorber/desorber is configured to absorb a portion of the refrigerant vapor in the closed-circuit refrigerant fluid path when the absorber/desorber operates as an absorber.

9. The thermal management system of claim 4, wherein the ionic liquid in the absorber/desorber is configured to desorb the refrigerant vapor stored in the absorber/desorber into the closed-circuit refrigerant fluid path when the absorber/desorber operates as a desorber.

10. The thermal management system of claim 4, wherein the absorber/desorber is configured to neither absorb vapor from the closed-circuit refrigerant fluid path by the ionic liquid nor desorb vapor stored by the ionic liquid in the absorber/desorber into the closed-circuit refrigerant fluid path.

11. The thermal management system of claim 4, wherein the closed-circuit refrigeration system further comprises:
a suction accumulator comprising an inlet that is coupled to the evaporator outlet and a vapor-side outlet that is coupled to the compressor inlet; and
a recuperative heat exchanger comprising:
a first refrigerant path disposed between the receiver outlet and the evaporator inlet, and
a second refrigerant path disposed between the vapor-side outlet and the compressor inlet.

12. The thermal management system of claim 4, wherein the closed-circuit refrigeration system further comprises:
an ejector comprising:
a primary inlet disposed to receive refrigerant fluid from the receiver,
a secondary inlet, and
an ejector outlet;
a liquid separator comprising an inlet, a vapor-side outlet, and a liquid-side outlet; and
an expansion valve comprising:
an expansion valve inlet coupled to the liquid-side outlet of the liquid separator, and
an expansion valve outlet.

13. The thermal management system of claim 12, wherein the secondary inlet of the ejector is disposed to receive refrigerant from the evaporator outlet, with the evaporator configured to convert a portion of the refrigerant fluid received from the expansion valve outlet to refrigerant vapor, and to deliver the refrigerant fluid including the converted refrigerant vapor to the secondary inlet.

14. The thermal management system of claim 12, wherein the secondary inlet of the ejector is disposed to receive refrigerant from the expansion valve outlet and the evaporator is disposed to receiver refrigerant fluid from the ejector outlet.

15. The thermal management system of claim 12, wherein the evaporator is a first evaporator, the thermal management system further comprising:
a second evaporator comprising an inlet and an outlet, with the inlet of the second evaporator disposed to receive refrigerant from the ejector outlet.

16. The thermal management system of claim 15, further comprising:
a sensor configured to sense a thermodynamic property of the refrigerant vapor at the outlet of the first evaporator to produce a sensor signal to directly or indirectly control operation of the expansion valve.

17. The thermal management system of claim 12, wherein the evaporator has a first fluid path and a second fluid path, with the ejector outlet coupled to an inlet of the first fluid path and an outlet of the first fluid path coupled to an inlet of the liquid separator, and with an inlet of the second fluid path coupled to the expansion valve outlet and an outlet of the second fluid path coupled to the secondary inlet of the ejector.

18. The thermal management system of claim 4, wherein the closed-circuit refrigeration system further comprises:
a liquid separator comprising an inlet, a vapor-side outlet, and a liquid-side outlet; and
a pump comprising a pump inlet and a pump outlet, with the pump inlet disposed to receive a refrigerant liquid from the liquid-side outlet of the liquid separator.

19. The thermal management system of claim 18, wherein the pump outlet is fluidly coupled to the evaporator inlet.

20. The thermal management system of claim 19, wherein the evaporator is a first evaporator and the evaporator inlet is a first evaporator inlet and the evaporator outlet is a first evaporator outlet, the thermal management system further comprising:
a second evaporator comprising a second evaporator inlet and a second evaporator outlet with the second evaporator inlet configured to receive refrigerant fluid from the first evaporator outlet.

21. The thermal management system of claim 18, wherein the evaporator has a first fluid path and a second fluid path, with the pump comprising the outlet coupled to an inlet of the first fluid path and comprising an outlet of the first fluid path coupled to an inlet of the second fluid path that also receives refrigerant from the receiver, and with the outlet of the second fluid path coupled to the inlet of the liquid separator.

22. The thermal management system of claim 4, further comprising:
a modulating capacity control circuit configured to modulate cooling capacity of the closed-circuit refrigeration system based at least in part on a cooling capacity demand on the closed-circuit refrigeration system that results at least in part from extraction of the heat from the at least one heat load, the modulating capacity control circuit configured to split compressed refrigerant vapor received from the compressor outlet into a first compressed portion and a second compressed portion, with the first compressed portion diverted to the condenser inlet.

23. The thermal management system of claim 22, wherein the modulating capacity control circuit is configured to divert a first sub-portion of the second compressed portion to the receiver inlet.

24. The thermal management system of claim 23, wherein the modulating capacity control circuit is configured to divert a second sub-portion of the second compressed portion towards the compressor inlet.

25. The thermal management system of claim 24, wherein the modulating capacity control circuit comprises:
a head pressure valve comprising:
a first inlet coupled to the condenser outlet,
a second inlet disposed to receive a first sub-portion of the first compressed portion, and
an outlet coupled to the receiver inlet, with the head pressure valve configured to divert the first sub-portion of the first compressed portion to the receiver inlet; and
a bypass valve that comprises a bypass valve inlet and a bypass valve outlet, with the bypass valve inlet disposed to receive the second sub-portion of the first compressed portion.

26. The thermal management system of claim 25, wherein the modulating capacity control circuit comprises:
a mixer, comprising:
a mixer inlet fluidly coupled to the outlet of the bypass valve, and
a mixer outlet fluidly coupled to the condenser inlet and the bidirectional port of the absorber/desorber;
a quench valve comprising an inlet coupled to the receiver outlet and an outlet coupled to the receiver outlet; and
a suction accumulator comprising a suction accumulator inlet coupled to the evaporator outlet and a suction accumulator vapor-side outlet coupled to the bidirectional port of the absorber/desorber, with the bypass valve outlet coupled to the mixer inlet, causing the second sub-portion of the first compressed portion to bypass the evaporator and the suction accumulator.

27. The thermal management system of claim 26, further comprising:
first and second sensors configured to sense thermodynamic properties of the refrigerant fluid at the mixer outlet and directly or indirectly control operation of the quench valve and the bypass valve.

28. The thermal management system of claim 27, further comprising a recuperative heat exchanger comprising:
a first refrigerant path disposed between the receiver outlet and the evaporator inlet, and
a second refrigerant path disposed between the vapor-side outlet and the compressor inlet.

29. The thermal management system of claim 22, further comprising:
a liquid separator comprising a liquid separator inlet, a vapor-side outlet, and a liquid-side outlet, with the vapor-side outlet fluidly coupled to the bidirectional port of the absorber/desorber and the compressor inlet; and
an ejector comprising a primary inlet disposed to receive refrigerant fluid from the receiver outlet, the ejector further comprising a secondary inlet and an ejector outlet.

30. The thermal management system of claim 22, further comprising:
a liquid separator comprising a liquid separator inlet, a vapor-side outlet, and a liquid-side outlet; and
a pump comprising a pump inlet disposed to receive refrigerant liquid from the liquid-side outlet and a pump outlet that outputs the refrigerant liquid to the evaporator inlet.

31. The thermal management system of claim 25, wherein the modulating capacity control circuit is further configured to divert the second sub-portion of the first compressed portion to the evaporator inlet to modulate a cooling capacity demand on the closed-circuit refrigeration system that results at least in part from extraction of the heat from the at least one heat load.

32. The thermal management system of claim 31, wherein the modulating capacity control circuit further comprises:
an expansion valve comprising an inlet that receives refrigerant fluid from the receiver outlet and an outlet that transports expanded refrigerant towards the evaporator inlet; and
first and second sensors configured to sense thermodynamic properties of the refrigerant fluid at the evaporator outlet to control operation of the expansion valve and the bypass valve.

33. The thermal management system of claim 4, wherein the closed-circuit refrigeration system comprises a heat pump, comprising:
a four-way valve disposed in the closed-circuit fluid path and comprising first, second, third, and fourth four-way valve ports to fluidly couple the four-way valve with the receiver, the evaporator, the condenser, and the compressor.

34. The thermal management system of claim 33, further comprising a suction accumulator comprising:
a suction accumulator inlet coupled to one of the four-way valve ports, and
a suction accumulator vapor-side outlet coupled to the compressor inlet and the bidirectional port of the absorber/desorber.

35. The thermal management system of claim 33, wherein the heat pump comprises:
a first by-passable expansion valve coupled between the receiver outlet and the evaporator inlet, and
a second by-passable expansion valve coupled between the receiver inlet and the condenser outlet.

36. The thermal management system of claim 34, wherein the first by-passable expansion valve is configured to expand the refrigerant fluid to produce a mixed liquid-vapor refrigerant fluid that flows into the suction accumulator for a cooling mode of operation.

37. The thermal management system of claim 35, wherein the second by-passable expansion valve is configured to expand the refrigerant fluid to produce a mixed liquid-vapor refrigerant fluid that flows into the condenser for a heating mode of operation.

38. The thermal management system of claim 33, further comprising:
a liquid separator comprising a liquid separator inlet, a vapor-side outlet, and a liquid-side outlet, the liquid separator inlet coupled to one of the four-way valve ports and the vapor-side outlet coupled to the compressor inlet and the bidirectional port of the absorber/desorber; and
an ejector comprising a primary inlet disposed to receive refrigerant from the receiver, a secondary inlet that receives refrigerant liquid from the liquid-side outlet of the liquid separator, and an ejector outlet that transports refrigerant fluid to the evaporator inlet.

39. The thermal management system of claim 33, further comprising:
a liquid separator comprising a liquid separator inlet, a vapor-side outlet, and a liquid-side outlet, the liquid separator inlet coupled to one of the four-way valve ports, and the vapor-side outlet coupled to the compressor inlet and the bidirectional port of the absorber/desorber; and
a pump comprising a pump inlet disposed to receive refrigerant liquid from the liquid-side outlet and a pump outlet that outputs pumped refrigerant liquid to the evaporator inlet.

40. The thermal management system of claim 33, further comprising:
a control system configured to control operation of the four-way valve, with the control system controlling the heat pump to operate in a cooling mode to transfer heat from the at least one heat load to the refrigerant fluid or controlling the heat pump to operate in a heating mode to transfer heat to the at least one heat load from the refrigerant fluid.

41. The thermal management system of claim 4, wherein the closed-circuit refrigeration system comprises:
a vapor compression closed-circuit system that includes the receiver, the at least one evaporator, the compressor, and the condenser; and
a closed-circuit system that includes the receiver and a closed-circuit evaporator, the closed-circuit system configured to receive refrigerant fluid from the receiver and transport the refrigerant fluid through the closed-circuit evaporator to cool a high temperature heat load.

42. The thermal management system of claim 41, wherein the closed-circuit system comprises a closed-circuit pumping system that comprises:
a pump disposed to receive refrigerant fluid from the receiver and configured to circulate the refrigerant fluid to an inlet of the closed-circuit evaporator, with the closed-circuit evaporator comprising an outlet that delivers refrigerant fluid to the condenser inlet.

43. The thermal management system of claim 42, wherein the compressor comprises an economizer port disposed to receive refrigerant fluid from the closed-circuit evaporator.
